(19) United States
(12) Patent Application Publication
(10) Pub. No.: US 2019/0283180 A1
(43) Pub. Date: Sep. 19, 2019

(54) LASER PRINTING WITH DEVICE THAT INCLUDES VOICE COIL-ACTIVATED LENS

(71) Applicant: Markem-Imaje Corporation, Keene, NH (US)

(72) Inventor: Ashoke Kumar Banerjee, Troy, NH (US)

(21) Appl. No.: 16/432,613

(22) Filed: Jun. 5, 2019

Related U.S. Application Data
(60) Provisional application No. 62/681,571, filed on Jun. 6, 2018.

(51) Int. Cl. B23K 26/08; B41J 2/47; B23K 26/06

(52) U.S. Cl. CPC B23K 26/0838; B23K 26/0648; B41J 2/47

(57) ABSTRACT

A laser scanning device for marking objects includes an optical port configured and arranged to receive a laser beam; a lens configured and arranged to focus the laser beam to modify a surface of a material to be marked; and an electrically controlled linear actuator coupled with the lens. The electrically controlled linear actuator is configured to move the lens linearly, thereby causing the laser beam to scan across the surface of the material to be marked as a result of changes in a refraction angle, of the laser beam passing through the lens, caused by the linear movement.

### CROSS-REFERENCE TO RELATED APPLICATION

This application claims the benefit of priority from U.S. Provisional Application No. 62/681,571 entitled “Laser Printing with Device That Includes Voice Coil-Activated Lens” and filed on Jun. 6, 2018, which is incorporated herein by reference in its entirety.

### BACKGROUND

Laser scanning devices are used for code marking applications on consumer packages. The information printed includes expiration date, manufactured by, or one or two dimensional product barcodes. Such devices include a laser source that gives out a Gaussian beam of a few mm in diameter with some slow divergence. The beam is then expanded and collimated using a few lenses. The collimated beam is then scanned by using scanning mirrors, e.g., a pair of galvanometers or a polygon scanner. The scanned collimated expanded beam is then collected by a lens or lenses to focus the beam at some distance away on a target where it burns a dot or mark. Such scanning of a beam across the surface of the focus lens usually has a distortion which is corrected by software that instructs the scan mirrors how far (+/− degrees) it should scan to bring the focus on an undistorted grid line and thus avoid distortion. A laser scanning device, also referred to as a scan head, containing the foregoing optics, scan mirrors and focus lenses, along with a controller, electronic circuits and cooling fans, usually has a size in excess of 6″×6″×7″. Some housings can be slightly smaller and yet some are larger.

### SUMMARY

Implementations of a scan head described herein include a lens to focus a laser beam to modify a surface of a material to be marked, and a voice-coil actuator coupled with the lens. The voice-coil actuator moves the lens linearly and, thus, causes the laser beam to scan across the surface of the material to be marked as a result of changes in a refraction angle, of the laser beam passing through the lens, caused by the linear movement. The disclosed scan head equally is usable with dot matrix and vector type laser marking. As such, both dot matrix and vector style printing can be done using disclosed scanning methods. The disclosed scan head is compatible with different laser sources such as CO₂, UV and Long Infrared and can eliminate the need for using galvanometer and polygon scanners.

According to an aspect of the disclosed technologies, a laser scanning device for marking objects is described. The laser scanning device includes an optical port configured and arranged to receive a laser beam; a lens configured and arranged to focus the laser beam to modify a surface of a material to be marked; and an electrically controlled linear actuator coupled with the lens. The electrically controlled linear actuator is configured to move the lens linearly, thereby causing the laser beam to scan across the surface of the material to be marked as a result of changes in a refraction angle, of the laser beam passing through the lens, caused by the linear movement.

The foregoing and other embodiments can each optionally include one or more of the following features, alone or in combination. In some implementations, the laser scanning device can include a first reflector optically coupled with the optical port, and a second reflector optically coupled with the first reflector and the lens. Here, the first reflector is (i) arranged to receive the laser beam from the optical port along a first direction, and (ii) configured to redirect the laser beam to the second reflector along a second direction. Additionally, the second reflector is arranged to receive the laser beam along the second direction, and redirect the laser beam to the lens along a third direction.

In some of the foregoing implementations, the first reflector can include a first mirror, and the second reflector can include a second mirror. In some of the foregoing implementations, the laser scanning device can include a translation stage that supports the first reflector and the second reflector, in addition to the electrically controlled linear actuator and thus the lens. Here, the translation stage is configured to move, as a unit, each of the first mirror, the second mirror, the electrically controlled linear actuator, and the lens, along a line that is parallel to the first direction. In some cases, the translation stage can include a table, a thread shaft, and a stepper motor.

In some of the foregoing implementations, the second direction is along an X dimension in a three dimensional space, and the first reflector can be arranged in a plane tilted at a fixed forty five degree angle relative to a (X,Z)-plane and normal to a (X,Y)-plane in the three dimensional space. The third direction is along a Y dimension in the three dimensional space, and the second mirror can be arranged in a plane tilted at a fixed forty five degree angle relative to the (X,Z)-plane and normal to a (Y,Z)-plane in the three dimensional space. Additionally, the first direction is along a Z dimension in the three dimensional space.

In some of the foregoing implementations, the electrically controlled linear actuator can be a first electrically controlled linear actuator configured to move the lens along the second direction. Here, the laser scanning device can include a second electrically controlled linear actuator coupled with the first electrically controlled linear actuator. The second electrically controlled linear actuator is configured to move the first electrically controlled linear actuator, and thus the lens, along the third direction to adjust the focus of the laser beam on the surface of the material to be marked.

In some of the foregoing implementations, the laser scanning device can include a third electrically controlled linear actuator coupled with the first electrically controlled linear actuator. The third electrically controlled linear actuator is configured to move, as a unit, the second mirror and the first electrically controlled linear actuator, and thus the lens, along the second direction to adjust a centered position of the lens, thereby providing an increased marking area for the laser scanning device.

In some implementations, the optical port can include a fiber optic cable connector configured to hold an output end of a fiber optic cable. The fiber optic cable connector can be disposed adjacent to the lens and arranged to direct to the lens along a third direction the laser beam guided through the fiber optic cable and output at its output end.

In some of the foregoing implementations, the laser scanning device can include a translation stage that supports the fiber optic cable connector, and the electrically controlled linear actuator and thus the lens. The translation stage is configured to move, as a unit, each of the fiber optic cable connector, the electrically controlled linear actuator, and the lens, along a line that is parallel to a first direction orthogonal to the third direction. In some of the foregoing implementations, the electrically controlled linear actuator can be a first electrically controlled linear actuator configured to move the lens along a second dimension orthogonal to the first and third directions. Here, the laser scanning device can include a second electrically controlled linear actuator coupled with the first electrically controlled linear actuator. The second electrically controlled linear actuator is configured to move, as a unit, the fiber optic cable connector, the first electrically controlled linear actuator, and thus the lens, farther along the second dimension to adjust a centered position of the lens, thereby providing an increased marking area for the laser scanning device.

In some of the foregoing implementations, the laser scanning device can include a third electrically controlled linear actuator coupled between the first electrically controlled linear actuator and the second electrically controlled linear actuator. The third electrically controlled linear actuator is configured to move the first electrically controlled linear actuator, and thus the lens, along the third direction to adjust the focus of the laser beam on the surface of the material to be marked.

In some of the foregoing implementations, a ratio of a diameter of the lens divided by a diameter of the laser beam can be between 1.1 and 5.1, between 1.1 and 4.1, between 1.1 and 3.1, or between 1.1 and 2.1. Here, the diameter of the laser beam can be about 2.5 mm, the diameter of the lens can be about 3.5 mm, and a scanning distance covered by the changes in the refraction angle between 15 mm and 57 mm.

In some of the foregoing implementations, any of the electrically controlled linear actuators referenced therein can include either a voice-coil actuator or a linear DC motor. In some of the foregoing implementations, the linear motion of the lens caused by the electrically controlled actuator coupled with the lens can be along a linear path or an arcuate path.

According to another aspect of the disclosed technologies, a laser marking system includes a laser scan head including any one of some of the foregoing implementations of the laser scanning device. Additionally, the laser marking system includes a laser source configured and arranged to provide the laser beam to the optical port of the laser scan head along the first direction.

According to another aspect of the disclosed technologies, a laser marking system includes a laser scan head including any one of some of the foregoing implementations of the laser scanning device. Additionally, the laser marking system includes a laser source configured and arranged to provide the laser beam, and the fiber optic cable connected at its input end to the laser source and at its output end to the fiber optic cable connector of the laser scan head to guide the laser beam from the laser source to the laser scan head.

The foregoing and other embodiments can each optionally include one or more of the following features, alone or in combination. In some implementations, the laser marking system can include a controller coupled with the laser scan head and configured to send electrical signals to the electrically controlled linear actuator to move the lens to effect dot matrix or vector type laser marking on products, when the products move in front of the laser scan head on a conveyor in a product manufacturing or packaging facility.

According to another aspect of the disclosed technologies, a method of operating the laser marking system, substantially as shown and described.

Particular aspects of the disclosed technologies can be implemented to realize one or more of the following potential advantages. For example, using a voice-coil actuator with spring return to activate a lens of a scan head is the most compact, lowest-cost and simplest to implement solution for scan-head operation. For instance, the small size of the disclosed scan heads enables their use for new printing applications that cannot be performed with larger conventional scan heads which use galvanometers for operation.

Details of one or more implementations of the disclosed technologies are set forth in the accompanying drawings and the description below. Other features, aspects, descriptions and potential advantages will become apparent from the description, the drawings and the claims.

### BRIEF DESCRIPTION OF THE DRAWINGS

FIGS. 1A-1D show aspects of a laser scanning technique which uses a voice-coil actuator to move a lens transversely to a laser beam for scanning the laser beam in the direction of the actuated motion.

FIGS. 1E-1H show aspects of a laser scanning technique which uses a voice-coil actuator to rotate a lens about a rotation axis orthogonal to a laser beam for scanning the laser beam in a direction orthogonal to both the rotation axis and the laser beam.

FIGS. 2A-2C show aspects of a laser marking system which includes an example of a scan head that uses a voice coil-actuated lens and discrete beam-steering optics.

FIGS. 3A-3B show aspects of a laser marking system which includes another example of a scan head that uses a voice coil-actuated lens and a fiber optic cable.

FIGS. 4A-4B show an example of a scan head that uses discrete beam-steering optics to deliver a laser beam to a lens actuated by a combination of voice-coil actuators for scanning and focusing the laser beam.

FIGS. 5A-5B show an example of a scan head that uses a fiber optic cable to deliver a laser beam to a lens actuated by a combination of voice-coil actuators for scanning and focusing the laser beam.

FIGS. 6A-6B show an example of a scan head that uses discrete beam-steering optics to deliver a laser beam to a lens actuated by a combination of voice-coil actuators for extending a range over which the laser beam is being scanned.

FIGS. 7A-7B show an example of a scan head that uses a fiber optic cable to deliver a laser beam to a lens actuated by a combination of voice-coil actuators for extending a range over which the laser beam is being scanned.

FIG. 8 shows a laser marking system which includes an example of a scan head that uses discrete beam-steering optics to deliver a laser beam to a lens actuated by a combination of voice-coil actuators for scanning the laser beam along transverse directions orthogonal to each other.

FIG. 9 shows a laser marking system which includes an example of a scan head that uses a fiber optic cable to deliver a laser beam to a lens actuated by a combination of voice-coil actuators for scanning the laser beam along transverse directions orthogonal to each other.

FIG. 10 is a diagram of a laser marking system which includes a scan head that uses one or more of the voice-coil actuators illustrated in the previous figures to activate a lens for scanning a laser beam over a printing target.

Certain illustrative aspects of the disclosed technologies are described herein in connection with the following description and the accompanying figures. These aspects are, however, indicative of but a few of the various ways in which the principles of the disclosed technologies may be employed and the disclosed technologies are intended to include all such aspects and their equivalents. Other advantages and novel features of the disclosed technologies may become apparent from the following detailed description when considered in conjunction with the figures.

### DETAILED DESCRIPTION

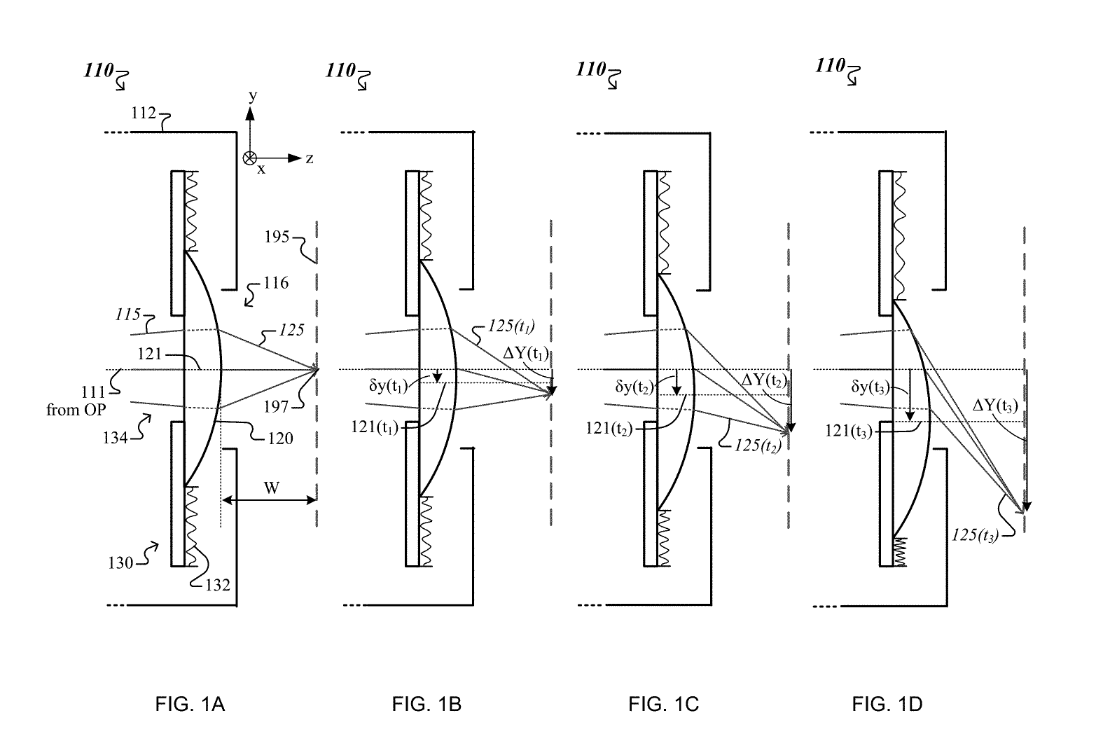

FIGS. 1A-1D show aspects of a laser scanning technique which uses a voice-coil actuator 130 to move a lens 120 transversely to an incident laser beam 115 for scanning the laser beam in the direction of the lens' motion. FIGS. 1E-1H show aspects of a laser scanning technique which uses a voice-coil actuator 130R to rotate the lens 120 about a rotation axis 133 orthogonal to the incident laser beam 115 for scanning the laser beam in a direction orthogonal to both the rotation axis and the laser beam.

FIG. 1A is a cross-section view, e.g., parallel to the (y,z)-plane, of a laser-scanning device, also referred to as a scan head, 110, which includes the voice-coil actuator 130 and the lens 120 coupled with the voice-coil actuator. FIG. 1E is a cross-section view, e.g., parallel to the (y,z)-plane, of a scan head 110R, which includes the lens 120 and the voice-coil actuator 130R coupled with the lens.

Referring to both FIGS. 1A and 1E, the voice-coil actuator 130, 130R, also referred to as a voice-coil motor, has a through hole, referred to as actuator aperture, 134, 134R. The actuator aperture, 134, 134R has an actuator-aperture axis 111. The lens 120 is coupled to the voice-coil actuator 130, 130R to cover the actuator aperture 134, 134R.

The scan head 110, 110R has a housing 112 and a scanning aperture 116, which is an opening in the housing. The voice-coil actuator 130, 130R is disposed adjacent to the scanning aperture 116. The lens 120 coupled to the voice-coil actuator 130, 130R (i) has an optical axis 121, e.g., along the z-axis, and (ii) is facing outside the housing 112 through the scanning aperture 116. During operation of the scan head 110, 110R, an incident laser beam 115 provided to the scan head through an input optical port (not shown in FIGS. 1A-1H) is directed to the lens 120 along the actuator-aperture axis 111 through the actuator aperture 134, 134R. The lens 120 is configured to focus a transmitted laser beam 125 to a target surface 195, which (i) is spaced apart from the lens by a working distance W, e.g., along the z-axis, and (ii) extends transversely to the actuator-aperture axis 111, e.g., parallel to the (x,y)-plane, within a field of view defined by the scanning aperture 116. When the optical axis 121 of the lens 120 coincides with the actuator-aperture axis 111, the lens 120 focuses the transmitted laser beam 125 at an intersection point 197 of the actuator-aperture axis with the target surface 195. Note that the working distance W of the scan head 110, 110R is determined by the focal length of the lens 120, which here is in the range of 15-50 mm.

Referring now to the example illustrated in FIG. 1A, the voice-coil actuator 130 is a voice-coil actuator with spring return, thus it includes two or more springs 132 arranged to compress and extend orthogonal to the actuator-aperture axis 111, here along the y-axis. As such, when the voice-coil actuator 130 has been activated, the springs 132 are configured to linearly move the lens 120 transversely to the actuator-aperture axis 111. The voice-coil actuator 130 works like a solenoid where a coil of wire is energized creating an electromagnet. The electromagnet is used to then draw in a metal shuttle that is attached to the lens 120 causing the lens to move. The springs 132 within the voice-coil actuator 130 put a force on the lens 120 allowing the lens to move back into its home position when power is removed from the electromagnet.

FIGS. 1B, 1C and 1D show instances of the scan head 110 at sequential times t₁, t₂, t₃, respectively. At times t₁, t₂, t₃, the lens 120 has been linearly moved along a linear path perpendicular to the actuator-aperture axis 111, such that instances of its optical axis 121(t₁), 121(t₂), 121(t₃) have shifted by corresponding lens displacements δy(t₁), δy(t₂), δy(t₃) relative to the actuator-aperture axis. Note that a ratio of the lens 120's diameter and the actuator aperture 134′ diameter is configured such that the lens covers the actuator aperture for any lens displacements |δy(t)|<δy_{MAX} caused by the voice-coil actuator 130. However, because it is desirable for the voice coil actuator 130 to move or tilt the lens 120 at high speeds, e.g., at speeds of order 32 ft./sec or higher which are comparable to linear speeds of commercially available galvanometer scanning mirrors or polygon scanners, the lens 120 should be very light. Therefore, the lens 120 is configured to be just a little larger than a diameter of the incident laser beam 121. Since the diameter of the incident laser beam 121 is about 3 mm or less, the lens 120's diameter is designed to be 5 mm or less, for example in a range of 3.5-5 mm. As another example, a ratio of a diameter of the lens 120 divided by a diameter of the incident laser beam 115 is between 1.1 and 5.1, between 1.1 and 4.1, between 1.1 and 3.1, or between 1.1 and 2.1.

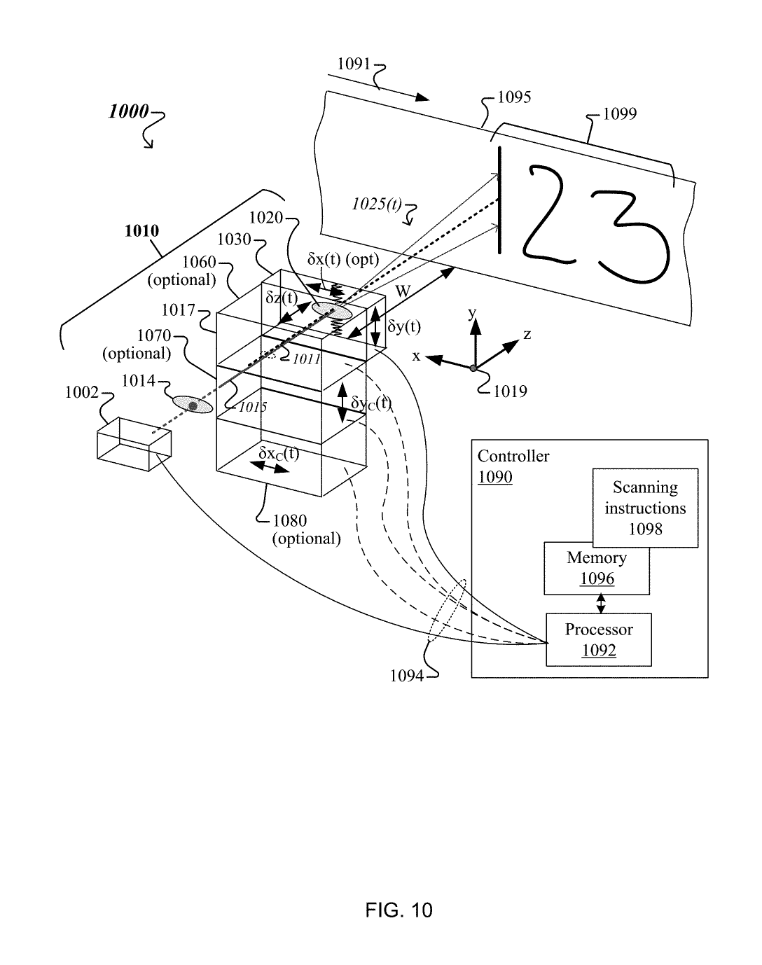

Because at times t₁, t₂, t₃ the incident laser beam 115 impinges on different portions of the lens 120, shifted relative to each other along the y-axis, instances of the transmitted laser beam 125(t₁), 125(t₂), 125(t₃) will be redirected by the lens, through refraction, relative to the actuator-aperture axis 111 to different points of the target surface 195 separated from the intersection point 197 by corresponding target displacements ΔY(t₁), ΔY(t₂), ΔY(t₃). Note that, because the lens 120 is configured as a lens that is color corrected and free of spherical aberrations, the target displacements ΔY(t₁), ΔY(t₂), ΔY(t₃) of points on the target surface 195, where corresponding instances of the transmitted laser beam 125(t₁), 125(t₂), 125(t₃) will focus, are deterministically related to (i) the lens displacements δy(t₁), δy(t₂), δy(t₃) of the instances of the optical axis 121(t₁), 121(t₂), 121(t₃) of the lens 120, as imparted by the springs 132 of the voice-coil actuator 130, (ii) the refractive index of the material from which the lens 120 is made, and (iii) the wavelength of the laser beam 115 incident on the lens. For instance, mappings of actuating voltages v(t) (to be applied to terminals of the voice-coil actuator 130) to lens displacements δy(t) to target displacements ΔY(t) will be established and stored, e.g., in look-up-tables. Such stored mappings {v(t), δy(t), ΔY(t)} can be provided to a controller (e.g., 1090 in FIG. 10) to control operation of the scan head 110.

In other embodiments, not shown in FIGS. 1A-1D, the voice-coil actuator 130 can be rotated by 90° about the z-axis, such that its springs 132 are arranged to compress and extend along the x-axis. When the voice-coil actuator has been activated, the springs 132 arranged in such rotated configuration will linearly move the lens 120 transversely to the actuator-aperture axis 111 and parallel to the x-axis, e.g., in-and-out of the page. In such cases, target displacements ΔX(t) of points on the target surface 195 where corresponding instances of the transmitted laser beam will focus would be deterministically related, at least, to lens displacements δx(t) of instances of the optical axis 121(t) of the lens 120, as imparted by x-direction-moving springs of the rotated voice-coil actuator 130.

Referring now to the example illustrated in FIG. 1E, the voice-coil actuator 130R is a voice-coil actuator with spring return, thus it includes two or more springs 132R arranged to compress and extend parallel to the actuator-aperture axis 111, here along the z-axis. As such, when the voice-coil actuator 130R has been activated, the springs 132R are configured to rotate the lens 120 about the rotation axis 133. Here, the optical axis 121 of the un-rotated lens 120 coincides with the actuator-aperture axis 111, and the rotation axis 133 is parallel to the x-axis. FIGS. 1F, 1G and 1H show instances of the scan head 110R at sequential times t₁, t₂, t₃, respectively. At times t₁, t₂, t₃, the lens 120 has been rotated about the rotation axis 133, such that instances of its optical axis 121(t₁), 121(t₂), 121(t₃) have rotated by corresponding lens rotations δθ(t₁), δθ(12), δθ(13) relative to the actuator-aperture axis 111. Note that a ratio of the lens 120's diameter and the actuator aperture 134R′ diameter is configured such that the lens covers the actuator aperture for any lens rotations |δθ(t)|<δθ_{MAX} caused by the voice-coil actuator 130R. Because at times t₁, t₂, t₃ the incident laser beam 115 impinges on the lens 120 at different orientations, rotated relative to each other about the rotation axis 133, instances of the transmitted laser beam 125(t₁), 125(t₂), 125(t₃) will be redirected by the lens, through refraction, relative to the actuator-aperture axis 111 to different points of the target surface 195 separated from the intersection point 197 by corresponding target displacements ΔY(t₁), ΔY(t₂), ΔY(t₃). Note that, because the lens 120 is configured as a lens that is color corrected and free of spherical aberrations, the target displacements ΔY(t₁), ΔY(t₂), ΔY(t₃) of points on the target surface 195, where corresponding instances of the transmitted laser beam 125(t₁), 125(t₂), 125(t₃) will focus, are deterministically related to (i) the rotations δθ(t₁), δθ(12), δθ(13) about the rotation axis 133 (i.e., about the x-axis) of the instances of the optical axis 121(t₁), 121(t₂), 121(t₃) of the lens 120, as imparted by the springs 132R of the voice-coil actuator 130R, (ii) the refractive index of the material from which the lens 120 is made, and (iii) the wavelength of the laser beam 115 incident on the lens. In this manner, mappings of actuating voltages v(t) (to be applied to terminals of the voice-coil actuator 130R) to lens rotations 60(t) to target displacements ΔY(t) will be established and stored, e.g., in look-up-tables. Such stored mappings {θ(t), δy(t), ΔY(t)} can be provided to a controller (e.g., 1090 in FIG. 10) to control operation of the scan head 110R.

In other embodiments, not shown in FIGS. 1E-1H, the voice-coil actuator 130R can be rotated by 90° about the z-axis, such that its rotation axis 133 are arranged parallel to the x-axis. When activated in such rotated configuration, the springs 132R will rotate the lens 120 about the rotation axis 133 now parallel to the x-axis, e.g., in-and-out of the page. In such cases, rotations 60(t) about the y-axis of instances of the optical axis 121(t) of the lens 120, as imparted by z-direction-moving springs of the rotated voice-coil actuator 130R, would be deterministically related to target displacements ΔX(t) of points on the target surface 195 where corresponding instances of the transmitted laser beam will focus.

Referring now to FIGS. 1A-1H, the voice-coil actuator 130, 130R is a simple type of electric motor which includes magnetic housing and one or more coils. When electricity passes through a coil, it produces a magnetic field that reacts with a permanent magnet to either repel or attract the coil. The movement of the coil is restricted such that it can only move along its axis. Applying a voltage across terminals of the voice-coil actuator 130, 130R causes the voice-coil actuator to move the lens 120 in one direction. Reversing the polarity of the applied voltage will cause the voice-coil actuator 130, 130R to move the lens 120 to the opposite direction. The generated electromagnetic force is proportional to the flux crossing the coil and the current that flows through the coil. This force is almost constant in the specified stroke range of the voice-coil actuator 130, 130R. Movements of the lens 120 caused by the voice-coil actuator 130, 130R are repeatable and gearless, with the lens 120′ position fixed by balancing electromagnetic and spring forces. The springs 132, 132R return the lens 120 to an un-compressed spring position, and no power is dissipated unless activation is required. Additionally, the voice-coil actuator 130, 130R is mechanically robust, shock-resistant, and has low-cost mechanics. Because the voice-coil actuator 130, 130R has no hysteresis, it has a direct current-vs-position relationship.

Also note that the laser beam 115 can be delivered to the lens 120 along the actuator-aperture axis 111 from the input optical port of each of the scan heads 110, 110R, either directly or over a beam path with an arbitrary number of two or more legs (aka path segments). Both types of laser beam delivery are described below, starting with laser beam delivery over a 3-legged beam path.

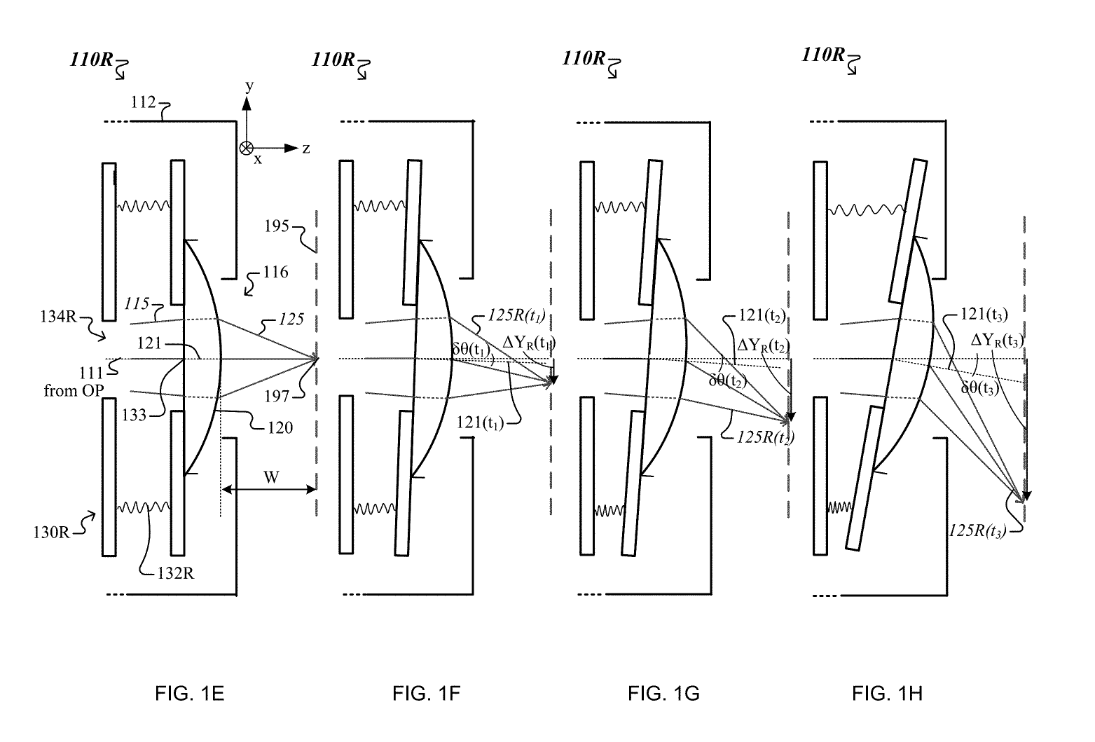

FIGS. 2A-2C show aspects of a laser marking system 200 which includes a scan head 210 that uses a voice coil-actuated lens 220/230 and discrete beam-steering optics 242, 244. FIG. 2A is a cross-section view, e.g., parallel to the (x,y)-plane, of the laser marking system 200 which includes, in addition to the scan head 210, a laser source 202. FIGS. 2B-2C are cross-section views, e.g., parallel to the (y,z)-plane, of instances of the scan head 210 corresponding to times t₁, t₂.

The scan head 210 has a housing 212. In addition to the beam steering optics 242, 244, the scan head 210 includes a lens 220 and a voice-coil actuator 230. The voice-coil actuator 230 has an actuator aperture 234, which has an actuator-aperture axis 211. The lens 220 is coupled to the voice-coil actuator 230 to cover the actuator aperture 234. The lens 220, the voice-coil actuator 230 and the beam steering optics 242, 244 are encompassed by the housing 212. The housing 212 has an input optical port 214, which is an opening in the housing. The laser source 202 can include one of a CO₂ laser, a UV laser or a Long Infrared laser. The laser source 202 is optically coupled to the scan head 210 to provide, during operation of the laser marking system 200, a laser beam 215 along a first direction, e.g., parallel to the x-axis, the provided laser beam to be received inside the scan head through the input optical port 214.

The housing 212 also has a scanning aperture 216, which is another opening in the housing. Inside the housing 212, the scan head 210 includes a chassis 217. The chassis 217 supports the voice-coil actuator 230 adjacent to the scanning aperture 216. The lens 220 coupled to the voice-coil actuator 230 (i) has an optical axis 221, e.g., along the z-axis, and (ii) is facing outside the housing 212 through the scanning aperture 216.

In the example illustrated in FIGS. 2A-2C, the beam steering optics include a first reflector 242 supported by the chassis 217 in a plane tilted at a fixed 45° angle relative to the (x,z)-plane and normal to the (x,y)-plane. Additionally, the beam steering optics include a second reflector 244 supported by the chassis 217 in a plane tilted at a fixed 45° angle relative to the (x,z)-plane and normal to the (y,z)-plane. The first reflector 242 is disposed on the chassis 217 to (i) receive from the input port 214 the laser beam 215 along the first direction, here parallel to the x-axis, and (ii) redirect the laser beam to the second reflector 244 along a second direction, here parallel to the y-axis. The second reflector 244 is disposed on the chassis 217 to (i) receive from the first reflector 242 the laser beam 215 along the second direction, and (ii) redirect the laser beam to the lens 220 along a third direction which coincides with the actuator-aperture axis 211. Here, the first reflector 242 and the second reflector 244 can be implemented as mirrors, reflecting prism surfaces, etc.

The lens 220 is configured to (i) receive from the second reflector 244 the incident laser beam 215 along the actuator-aperture axis 211 through the actuator aperture 234, and (ii) focus the transmitted laser beam 225 to a target surface 295. The target surface 295 (i) is spaced apart from the lens 220 by a working distance W along the actuator-aperture axis 211, here along the z-axis, and (ii) extends transversely to the actuator-aperture axis, here parallel to the (x,y)-plane, within a field of view defined by the scanning aperture 216. In the example illustrated in FIGS. 2A-2C, a conveyor 291 suitably moves the target surface 295 along the x-axis, such that the laser beam 225 transmitted through the lens 220 can be used to print, mark and/or burn a pattern (e.g., by ablation or using phase changing inks) extending on the target surface 295 along the x-axis.

The voice-coil actuator 230 includes two or more springs 232 arranged to compress and extend orthogonal to the actuator-aperture axis 211, here along the y-axis. As such, when the voice-coil actuator 230 has been activated, the springs 232 are configured to linearly move the lens 220 transversely to the actuator-aperture axis 211. At times t₁, t₂ the lens 220 has been linearly moved along a linear path perpendicular to the actuator-aperture axis 211, such that instances of its optical axis 221(t₁), 221(t₂) have shifted by corresponding lens displacements δy(t₁), δy(t₂) relative to the actuator-aperture axis. Note that at a time “t” when δy(t)=0, when the lens 220 is disposed such that its optical axis coincides with the actuator-aperture axis 211, the lens focuses the transmitted laser beam 225 at an intersection point 297 of the actuator-aperture axis with the target surface 295. However, because at times t₁, t₂ the incident laser beam 215 impinges on different portions of the lens 220, shifted relative to each other along the y-axis, instances of the transmitted laser beam 225(t₁), 225(t₂) will be redirected by the lens, through refraction, relative to the actuator-aperture axis 211 to different points of the target surface 295 separated from the intersection point 297 by corresponding target displacements ΔY(t₁), ΔY(t₂).

Note that this implementation of the voice-coil actuator 230 corresponds to the voice-coil actuator 130 described above in connection with FIGS. 1A-1D. In another implementation, the voice-coil actuator 230 can be implemented as the voice-coil actuator 130R described above in connection with FIGS. 1E-1H.

Delivery of the laser beam 215 to the voice-coil actuated lens 220 over the 3-legged beam path formed using the pair of reflectors 242, 244 is advantageous because the pair of reflectors ensures a more effective and efficient alignment procedure of the third direction of the laser beam 215 to the actuator-aperture axis 211. Note, however, that an overall size of the scan head 210 can be 15 mm×15 mm×15 mm. The size of a scan head along at least one direction, e.g., parallel to the y-axis, can be decreased compared to the scan head 210 if the laser beam were delivered directly to the voice-coil actuated lens, over a shorter, direct beam path, as described below.

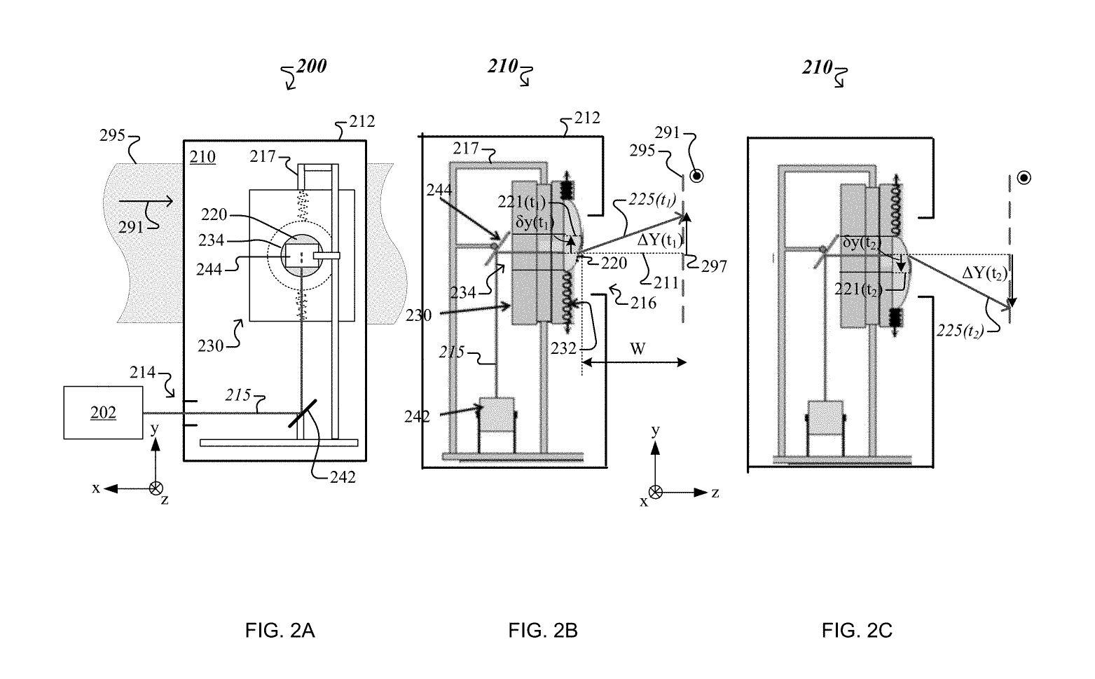

FIGS. 3A-3B are cross-section views, e.g., parallel to the (y,z)-plane, of instances of a laser marking system 300 corresponding to times t₁, t₂, where the laser marking system includes a scan head 310 that uses a voice coil-actuated lens 320/330 and a fiber optic cable 350. Here, the laser marking system 300 includes a laser source 302, in addition to the scan head 310 and the fiber optic cable 350.

In some implementations, the laser source 302 can include a CO₂ laser. Here, the fiber optic cable 350 can include one or more optical fibers configured to guide light emitted by CO₂ lasers. E.g., Polycrystaline InfraRed (PIR) Fiber is commercially available (e.g., PIR 400, PIR630, PIR900). In other implementations, laser source 302 can include one of a UV laser or a Long Infrared laser. Here, the fiber optic cable 350 will include fiber optics made from materials configured to guide UV light, and Long Infrared light, respectively.

The scan head 310 has a housing 312. Also, the scan head 310 includes a lens 320, a voice-coil actuator 330, and an input optical port 314. Here, the input optical port 314 is implemented as a fiber optic cable connector. The voice-coil actuator 330 has an actuator aperture 334, which has an actuator-aperture axis 311. The lens 320 is coupled to the voice-coil actuator 330 to cover the actuator aperture 334. The lens 320, the voice-coil actuator 330 and the input optical port 314 are encompassed by the housing 312. The housing 312 has a scanning aperture 316, which is an opening in the housing. Inside the housing 312, the scan head 310 also includes a chassis 317. The chassis 317 supports the voice-coil actuator 330 adjacent to the scanning aperture 316. The lens 320 coupled to the voice-coil actuator 330 (i) has an optical axis 321, e.g., along the z-axis, and (ii) is facing outside the housing 312 through the scanning aperture 316. The chassis 317 also supports the input optical port 314 adjacent to a side of the lens 320 opposing the lens side facing the scanning aperture 316.

The housing 312 also can have a source opening 318. The fiber optic cable 350 is connected at its input end to the laser source 302, crosses inside the housing 312 (e.g., through the source opening 318), and is connected at its output end to the input optic port 314 adjacent to the lens 320. In this manner, the fiber optic cable 350 provides at its output end, during operation of the laser marking system 300, laser light from the laser source 302 in the form of a laser beam 315 directed to the lens 320 along the actuator-aperture axis 311. Note that the fiber optic cable 350 has been provided with a loop 352 of extra length to avoid stressing the fiber optic cable adjacent to the source opening 318, and adjacent to the input optic port 314 (which is implemented as a fiber optic cable connector). In some implementations, the loop 352 is located outside of the housing 312 of the scan head 310 (e.g., the laser crosses into the housing 312 through the optic port 314 being integrated with the housing 312). Moreover, an overall size of the scan head 310 can be 15 mm×7.5 mm×15 mm, which is smaller than the overall size of the scan head 210 at least along the y-axis.

The lens 320 is configured to (i) receive directly from the input optical port 314 the incident laser beam 315 along the actuator-aperture axis 311 through the actuator aperture 334, and (ii) focus the transmitted laser beam 325 to a target surface 395. The target surface 395 (i) is spaced apart from the lens 320 by a working distance W along the actuator-aperture axis 311, here along the z-axis, and (ii) extends transversely to the actuator-aperture axis, here parallel to the (x,y)-plane, within a field of view defined by the scanning aperture 316. In the example illustrated in FIGS. 3A-3B, a conveyor 391 suitably moves the target surface 395 along the x-axis, such that the laser beam 325 transmitted through the lens 320 can be used to print, mark and/or burn a pattern (e.g., by ablation or using phase changing inks) extending on the target surface 395 along the x-axis.

The voice-coil actuator 330 includes two or more springs 332 arranged to compress and extend orthogonal to the actuator-aperture axis 311, here along the y-axis. As such, when the voice-coil actuator 330 has been activated, the springs 332 are configured to linearly move the lens 320 transversely to the actuator-aperture axis 311. At times t₁, t₂ corresponding to FIGS. 3A, 3B, respectively, the lens 320 has been linearly moved along a linear path perpendicular to the actuator-aperture axis 311, such that instances of its optical axis 321(t₁), 321(t₂) have shifted by corresponding lens displacements δy(t₁), δy(t₂) relative to the actuator-aperture axis. Note that at a time “t” when δy(t)=0, i.e., when the lens 320 is disposed such that its optical axis 321 coincides with the actuator-aperture axis 311, the lens 320 focuses the transmitted laser beam 325 at an intersection point 397 of the actuator-aperture axis with the target surface 395. However, because at times t₁, t₂ the incident laser beam 315 impinges on different portions of the lens 320, shifted relative to each other along the y-axis, instances of the transmitted laser beam 325(t₁), 325(t₂) will be redirected by the lens, through refraction, relative to the actuator-aperture axis 311 to different points of the target surface 395 separated from the intersection point 397 by corresponding target displacements ΔY(t₁), ΔY(t₂).

In some cases, the working distance W can vary. For example, the target surface 295, 395 can belong to objects to be marked by the laser marking system 200, 300, which can be placed closer or farther away from the lens 220, 320. For such cases, to preserve print quality on target objects disposed at variable spacing to the lens 220, 320, the scan head 210, 310 can be modified to allow for autofocusing the laser beam 225, 325 transmitted through the lens 220, 320 onto the target objects. The modification of the scan head 210 is described first, followed by the modification of the scan head 310.

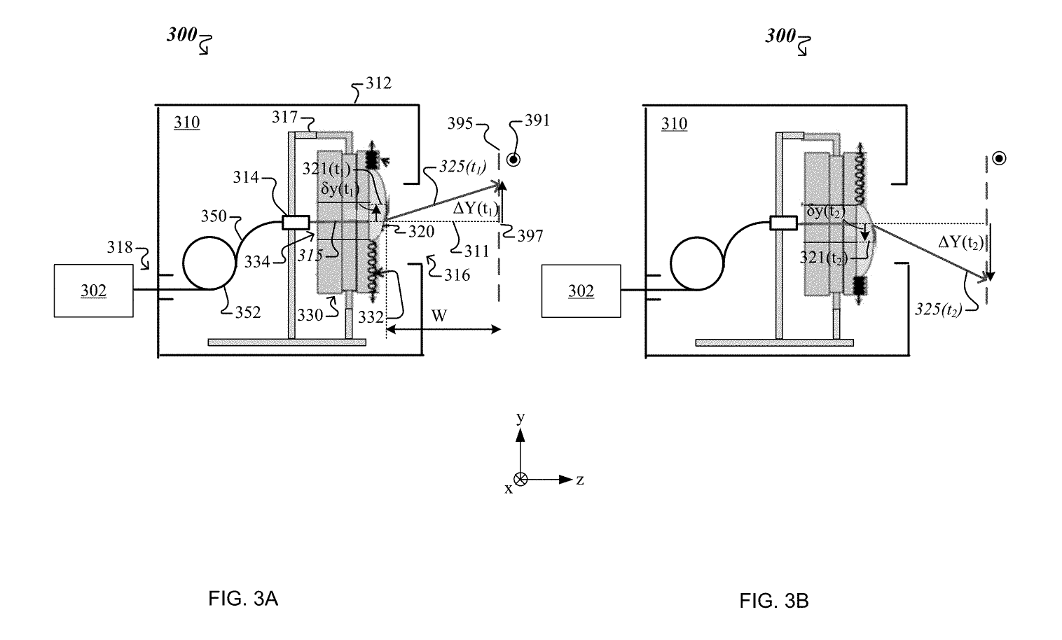

FIGS. 4A-4B are cross-section views, e.g., parallel to the (y,z)-plane, of instances of a scan head 410 that uses discrete beam-steering optics 442, 444 to deliver a laser beam 415 to a lens 420 actuated by a combination of voice-coil actuators 430, 460 for scanning and focusing the laser beam 425 transmitted through the lens. The scan head 410 has a housing 412. In addition to the beam steering optics 442, 444 and the lens 420, the scan head 410 includes a first voice-coil actuator 430 and a second voice-coil actuator 460. The lens 420 is coupled to the first voice-coil actuator 430, which is configured, e.g., like any one of the voice-coil actuators 130, 230 or 330, to move the lens transversely relative to its optical axis 421. The first voice-coil actuator 430 is coupled to the second voice-coil actuator 460. The second voice-coil actuator 460 is configured to move axially the first voice-coil actuator 430, and thus the lens 420, i.e., along the lens' optical axis 421. The second voice-coil actuator 460 includes two or more springs 462 arranged to compress and extend along the lens 420's optical axis 421, here along the z-axis. As such, when the second voice-coil actuator 460 has been activated, the springs 462 are configured to displace the first voice-coil actuator 430, and thus the lens 420, by an axial displacement δz(t)≠0 relative to an axial datum 419 (here a particular surface of a chassis 417). For instance, when the second voice-coil actuator 460 is not activated, i.e., when δz(t)=0, the lens 420 is spaced apart from the axial datum 419 by a predetermined axial distance Z₀. The first voice-coil actuator 430 and the second voice-coil actuator 460 combined in this manner are said to form a voice-coil actuator assembly 465. The voice-coil actuator assembly 465 has an actuator-assembly aperture 467, which has an actuator-aperture axis 411. Note that, here, the actuator-assembly aperture 467 is formed from co-axial through holes of the first voice-coil actuator 430 and a second voice-coil actuator 460, respectively. The lens 420 is coupled to the first voice-coil actuator 430 to cover the actuator-assembly aperture 467. The lens 420, the voice-coil actuator assembly 465 and the beam steering optics 442, 444 are encompassed by the housing 412.

The housing 412 has an input optical port (not shown in FIGS. 4A-4B) like the input optical port 212 described above in connection with FIG. 2A. A laser source (not shown in FIGS. 4A-4B) provides, during operation of the scan head 410, through the input optical port a laser beam 415 along a first direction, e.g., parallel to the x-axis. The housing 412 also has a scanning aperture 416, which is another opening in the housing. Inside the housing 412, the scan head 410 also includes the chassis 417 that supports the voice-coil actuator assembly 465 adjacent to the scanning aperture 416. Here, the second voice-coil actuator 460 of the assembly 465 is coupled to the chassis 417, while the lens 420 coupled to the first voice-coil actuator 430 of the assembly (i) is oriented with its optical axis 421 along the z-axis, and (ii) is facing outside the housing 412 through the scanning aperture 416.

In the example illustrated in FIGS. 4A-4B, the beam steering optics 442, 444 are (i) supported by the chassis 417 and (ii) implemented like the first and second reflectors 242, 244 described above in connection with FIGS. 2A-2C. In this manner, the first reflector 442 is disposed on the chassis 417 to (i) receive from the input port the laser beam 415 along the first direction and (ii) redirect the laser beam to the second reflector 444 along a second direction, here parallel to the y-axis. The second reflector 444 is disposed on the chassis 417 to (i) receive from the first reflector 442 the laser beam 415 along the second direction, and (ii) redirect the laser beam to the lens 420 along a third direction, which coincides with the actuator-aperture axis 411.

The lens 420 is configured to (i) receive from the second reflector 444 the incident laser beam 415 along the actuator-aperture axis 411 through the actuator-assembly aperture 467, and (ii) focus the transmitted laser beam 225 to a target surface 495, which is expected to be spaced apart from the lens by a working distance W along the actuator-aperture axis. The first voice-coil actuator 430, to which the lens is coupled, includes two or more springs 432 arranged to compress and extend orthogonal to the actuator-aperture axis 411, here along the y-axis. As such, when the first voice-coil actuator 430 has been activated, the springs 432 are configured to linearly move the lens 420 transversely to the actuator-aperture axis 411. At a time “t” the lens 420 has been linearly moved along a linear path perpendicular to the actuator-aperture axis 411, such that an instance of its optical axis 421(t) has shifted by a corresponding lens displacement δy(t)≠0 relative to the actuator-aperture axis. As described above in connection with FIGS. 2B-2C and 3A-3B, the finite lens displacement δy(t) causes that a corresponding instance of the transmitted laser beam 425(t) be redirected by the lens 420, through refraction, relative to the actuator-aperture axis 411 to a focal point in a focal plane spaced apart from the lens by the working distance W, the focal point separated along the y-axis from an axial focal point 497 by a corresponding target displacement ΔY(t).

Note, however, that in FIG. 4A, which shows the instance of the scan head 410 at time t₁, the optical axis 421 of the lens 420 is displaced by a lens displacement δy(t₁) relative to the actuator-aperture axis 411, and the lens is spaced apart from the axial datum 419 by Z₀. Under these conditions, the transmitted beam 425(t₁) is out-of-focus when it impinges on the target surface 495, because the target surface is farther away from the focal plane by W(t₁)−W. This causes the transmitted beam 425(t₁) to impinge on the target surface 495 as a “blurred” spot (instead of as a “sharp” in-focus point) separated along the y-axis from the actuator-aperture axis 411 by a target displacement ΔY_{B} larger than the expected ΔY(t₁). FIG. 4B shows that, at t₂, for a lens displacement of the optical axis 421(t₂) of the lens 420 equal to the one at t₁, δy(t₂)=δy(t₁), the second voice-coil actuator 460 has been activated using an autofocus procedure to move the first voice-coil actuator 430, and thus the lens, by an axial displacement δz(t₂)=W(t₁)−W. This projects the focal plane of the lens 420 onto the target surface 495. As such, at t₂ when δy(t₂)=δy(t₁), the transmitted beam 425(t₂) impinges on the target surface 495 as a sharp, in-focus point separated along the y-axis from the actuator-aperture axis 411 by a target displacement ΔY(t₂)=ΔY(t₁). The second voice-coil actuator 460 can produce axial shifts, here along the actuator-aperture axis 411, in a range of 5-15 mm, e.g., ±5 mm from the focus distance setup during the installation.

The noted autofocus procedure used for actuating the second voice-coil actuator 460 can be performed in real-time using known optical triangulation methods for determining the position of the target surface 495 relative the lens 420. A triangulation system can be used that includes a laser diode, one or more collection lenses, and a sensor having an array of pixels. For instance, the laser diode beam can direct a laser diode beam through a collection lens to the target surface 495 at an oblique angle. The same or another collection lens can collect a return beam scattered by the target surface and can direct the return beam on the array of pixels. Calibration aspects of this triangulation method include information relating (i) the pixel position of the center of the return beam on the array of pixels and to (ii) the distance between the lens 420 and the target surface 495. As such, when the distance along the z-axis between the lens 420 and the target surface 495 changes, the return beam will be scattered at a different angle, so the collection lens will direct it to a different position on the array of pixels. Once the triangulation system determines the magnitude and direction in which the lens 420 is displaced relative to the target surface 495 along the z-axis, the second voice-coil actuator 460 will be activated to move the lens 420 along the z-axis in real-time, as needed.

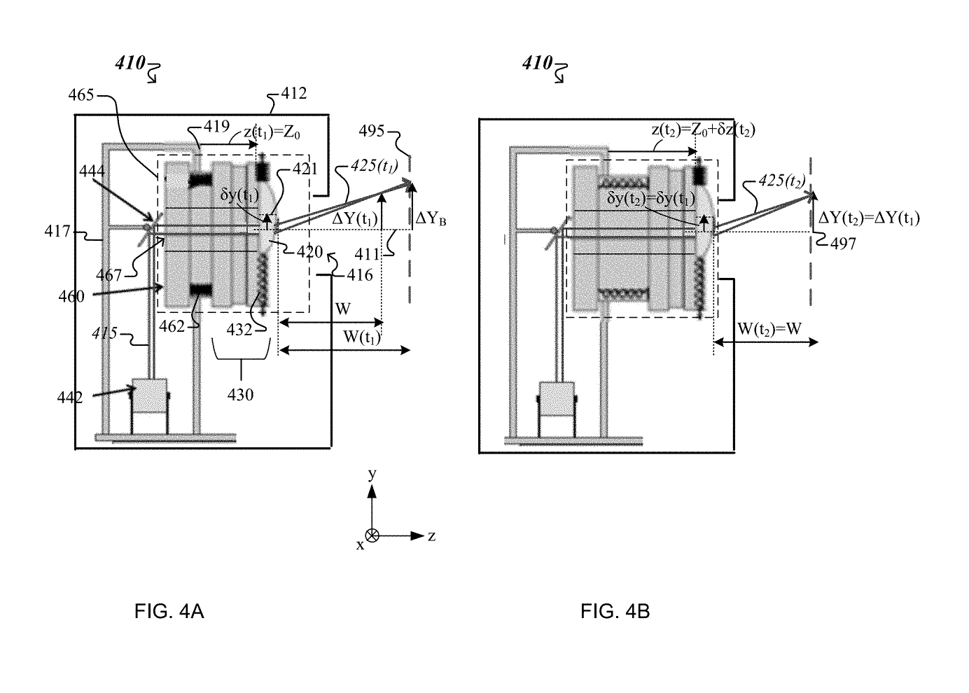

An autofocus modification similar to the one described above can be implemented for the scan head 310. FIGS. 5A-5B are cross-section views, e.g., parallel to the (y,z)-plane, of instances of a scan head 510 that uses a fiber optic cable 550 to deliver a laser beam 515 to a lens 520 actuated by a combination of voice-coil actuators 530, 560 for scanning and focusing the laser beam 525 transmitted through the lens. The scan head 510 has a housing 512. In addition to the lens 520, the scan head 510 includes a first voice-coil actuator 530 and a second voice-coil actuator 560. The lens 520 is coupled to the first voice-coil actuator 530, which is configured, e.g., like any one of the voice-coil actuators 130, 130R, 230, 330 or 430, to move the lens transversely relative to its optical axis 521. The first voice-coil actuator 530 is coupled to the second voice-coil actuator 560. The second voice-coil actuator 560 is configured to move axially the first voice-coil actuator 530, and thus the lens 520, i.e., along the lens' optical axis 521. The second voice-coil actuator 560 includes two or more springs 562 arranged to compress and extend along the lens 520's optical axis 521, here along the z-axis. As such, when the second voice-coil actuator 560 has been activated, the springs 562 are configured to displace the first voice-coil actuator 530, and thus the lens 520, by an axial displacement δz(t)≠0 relative to an axial-datum 519 (here a particular surface of a chassis 517). For instance, when the second voice-coil actuator 560 is not activated, i.e., when δz(t)=0, the lens 520 is spaced apart from the axial datum 519 by a predetermined axial distance Z₀. The first voice-coil actuator 530 and the second voice-coil actuator 560 combined in this manner are said to form a voice-coil actuator assembly 565. The voice-coil actuator assembly 565 has an actuator-assembly aperture 567, which has an actuator-aperture axis 511. Note that, here, the actuator-assembly aperture 567 is formed from co-axial through holes of the first voice-coil actuator 530 and the second voice-coil actuator 560, respectively. The lens 520 is coupled to the first voice-coil actuator 530 to cover the actuator-assembly aperture 567. The scan head 510 further includes an input optical port 514, e.g., implemented as the input port 314 described above in connection with FIGS. 3A-3B. The lens 520, the voice-coil actuator assembly 565 and the input optical port 514 are encompassed by the housing 512.

The housing 512 has a scanning aperture 516, which is an opening in the housing. Inside the housing 512, the scan head 510 also includes the chassis 517 that supports the voice-coil actuator assembly 565 adjacent to the scanning aperture 516. Here, the second voice-coil actuator 560 of the assembly 565 is coupled to the chassis 517, while the lens 520 coupled to the first voice-coil actuator 530 of the assembly (i) is oriented with its optical axis 521 along the z-axis, and (ii) is facing outside the housing 512 through the scanning aperture 516. The chassis 517 also supports the input optical port 514 adjacent to a side of the lens 520 opposing the lens side facing the scanning aperture 516. The housing 512 can have a source opening (not shown in FIGS. 5A-5B) like the source opening 318 described above in connection with FIGS. 3A-3B. The fiber optic cable 550 is connected at its input end to a laser source, crosses inside the housing 512 (e.g., through the source opening), and is connected at its output end to the input optic port 514 adjacent to the lens 520. In this manner, the fiber optic cable 550 provides at its output end, during operation of the scan head 510, laser light from the laser source in the form of a laser beam 515 directed to the lens 520 along the actuator-aperture axis 511.

The lens 520 is configured to (i) receive directly from the input optical port 514 the incident laser beam 515 along the actuator-aperture axis 511 through the actuator-assembly aperture 567, and (ii) focus the transmitted laser beam 525 to a target surface 595, which is expected to be spaced apart from the lens by a working distance W along the actuator-aperture axis. The first voice-coil actuator 530, to which the lens is coupled, includes two or more springs 532 arranged to compress and extend orthogonal to the actuator-aperture axis 511, here along the y-axis. As such, when the first voice-coil actuator 530 has been activated, the springs 532 are configured to linearly move the lens 520 transversely to the actuator-aperture axis 511. At a time “t”, the lens 520 has been linearly moved along a linear path perpendicular to the actuator-aperture axis 511, such that an instance of its optical axis 521(t) has shifted by a corresponding lens displacement δy(t)≠0 relative to the actuator-aperture axis. As described above in connection with FIGS. 2B-2C and 3A-3B, the finite lens displacement δy(t) causes that a corresponding instance of the transmitted laser beam 525(t) be redirected by the lens 520, through refraction, relative to the actuator-aperture axis 511 to a focal point in a focal plane spaced apart from the lens by the working distance W, the focal point separated along the y-axis from an axial focal point 597 by a corresponding target displacement ΔY(t).

Note, however, that in FIG. 5A, which shows the instance of the scan head 510 at time t₁, the optical axis 521(t₁) of the lens 520 is displaced by a lens displacement δy(t₁), and the lens is spaced apart from the axial datum 519 by Z₀. Under these conditions, the transmitted beam 525(t₁) is out-of-focus when it impinges on the target surface 595, because the target surface is farther away from the focal plane by W(t₁)−W. This causes the transmitted beam 525(t₁) to impinge on the target surface 595 as a “blurred” spot (instead of as a “sharp” in-focus point) separated along the y-axis from the actuator-aperture axis 511 by a target displacement ΔY_{B} larger than the expected ΔY(t₁). FIG. 5B shows that, at t₂, for a lens displacement of the optical axis 521(t₂) of the lens 520 equal to the one at t₁, δy(t₂)=δy(t₁), the second voice-coil actuator 560 has been activated using an autofocus procedure to move the first voice-coil actuator 530, and thus the lens, by an axial displacement δz(t₂)=W(t₁)−W. This projects the focal plane of the lens 520 onto the target surface 595. As such, at t₂ when δy(t₂)=δy(t₁), the transmitted beam 525(t₂) impinges on the target surface 595 as a sharp, in-focus point separated along the y-axis from the actuator-aperture axis 511 by a target displacement ΔY(t₂)=ΔY(t₁). The noted autofocus procedure used for actuating the second voice-coil actuator 560 can be performed in real-time using known optical triangulation methods for determining the position of the target surface 595 relative the lens 520, as described above in connection with the scan head 410.

Referring again to FIGS. 2A-2C and 3A-3B, the voice-coil actuator 230, 330 of the scan head 210, 310 can sweep the transmitted laser beam 225, 335 along the y-axis over a maximum scanning range 2ΔY_{MAX}. For the above-noted working distance W, the maximum scanning range can be between 15-57 mm.

In some cases, a pattern to be printed onto/burned into a target surface, e.g., 295, 395, 495, 595, extends over a range that is larger than a scanning extent, e.g., 2ΔY_{MAX}, achievable by actuating the voice-coil actuator 230, 330, 430, 530 to which the lens 220, 320, 420, 520 is coupled. For such cases, the scan head 210, 310, 410, 510 can be modified to shift the actuator-aperture axis 211, 311, 411, 511 along the scanning direction by a desired distance δY_{C} to increase the scanning extent e.g., to 2ΔY_{MAX}+δY_{C}. The modification of the scan head 210, 410 is described first, followed by the modification of the scan head 310, 510.

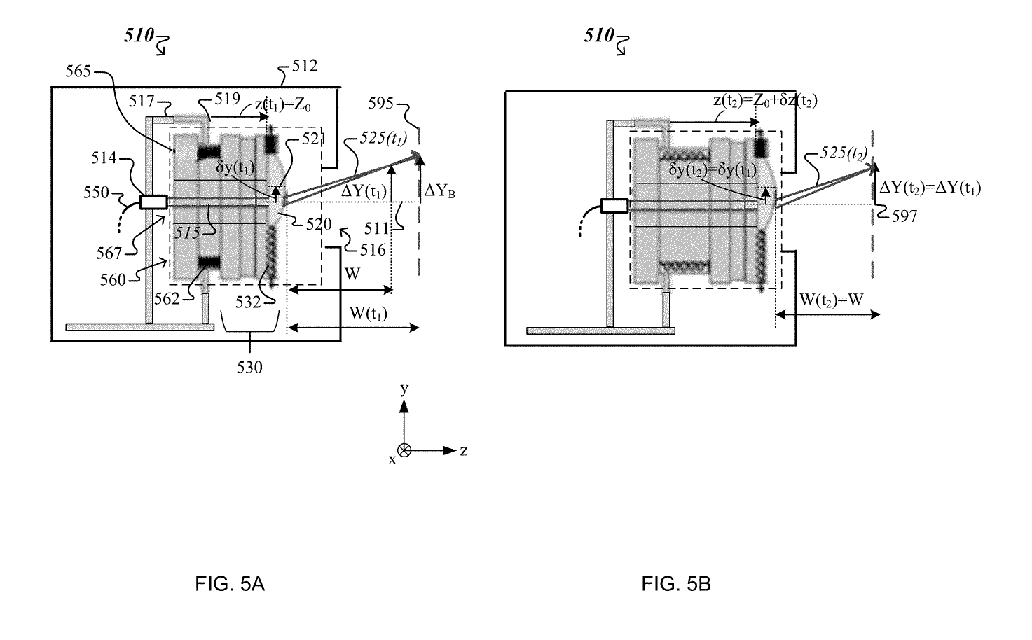

FIGS. 6A-6B are cross-section views, e.g., parallel to the (y,z)-plane, of instances of a scan head 610 that uses discrete beam-steering optics 642, 644 to deliver a laser beam 615 to a lens 620 actuated by a combination of voice-coil actuators 630, 670 for extending a range over which the laser beam 625 transmitted through the lens is being scanned. The scan head 610 has a housing 612. In addition to the beam steering optics 642, 644 and the lens 620, the scan head 610 includes a first voice-coil actuator 630 and a second voice-coil actuator 670. The lens 620, the first voice-coil actuator 630, the second voice-coil actuator 670, and the beam steering optics 642, 644 are encompassed by the housing 612.

The first voice-coil actuator 630 has a first actuator aperture 634, which has a first actuator-aperture axis 611, here along the z-axis. The lens 620 is coupled to the first voice-coil actuator 630 to cover the first actuator aperture 634. The first voice-coil actuator 630 is configured, e.g., like any one of the voice-coil actuators 130, 230, 330, 430 or 530, to move the lens 620 transversely relative to the first actuator-aperture axis 611, here along the y-axis. The first voice-coil actuator 630 is coupled to the second voice-coil actuator 670 through a coupling frame 617C. A chassis 617 of the scan head 610 supports the second voice-coil actuator 670 at a fixed location of the housing 612. The coupling frame 617C is configured to orient the first voice-coil actuator 630 and the second voice-coil actuator 670 relative to each other such that, when activated, the second voice-coil actuator 670 moves the first voice-coil actuator, and thus the first actuator-aperture axis 611, along a direction of the lens 620's motion caused by the first voice-coil actuator, here along the y-axis. The second voice-coil actuator 670 includes two or more springs 672 arranged to compress and extend along the y-axis. As such, when the second voice-coil actuator 670 has been activated, the springs 672 are configured to cause the second voice-coil actuator 670 to displace the first voice-coil actuator 630, and thus the first actuator-aperture axis 611 and the lens 620, by an additional displacement δY_{C}≠0 relative to a transverse datum 619 (here a particular surface of the chassis 617). For instance, when the second voice-coil actuator 670 is not activated, e.g., when δY_{C}=0, the first actuator-aperture axis 611 is spaced apart from the transverse datum 619 by a predetermined transverse distance Y₀. The first voice-coil actuator 630 and the second voice-coil actuator 670 combined in this manner are said to form a voice-coil actuator assembly 675.

The housing 612 has an input optical port (not shown in FIGS. 6A-6B) like the input optical port 214 described above in connection with FIG. 2A. A laser source (not shown in FIGS. 6A-6B) provides, during operation of the scan head 610, through the input optical port a laser beam 615 along a first direction, e.g., parallel to the x-axis. The housing 612 also has a scanning aperture 616, which is another opening in the housing. The chassis 617 supports the voice-coil actuator assembly 675 adjacent to the scanning aperture 616. In this manner, the lens 620 coupled to the first voice-coil actuator 630 of the assembly (i) is oriented with its optical axis 621 along the z-axis, and (ii) is facing outside the housing 612 through the scanning aperture 616.

In the example illustrated in FIGS. 6A-6B, the beam steering optics 642, 644 are (i) supported by the chassis 617 and the coupling frame 617C, respectively, and (ii) implemented like the first and second reflectors 242, 244 described above in connection with FIGS. 2A-2C. Also in the example illustrated in FIGS. 6A-6B, the second voice-coil actuator 670 has a second actuator aperture 674, which has a second actuator-aperture axis 671, here along the y-axis. In this manner, the first reflector 642 is disposed on the chassis 617 to (i) receive from the input port the laser beam 615 along the first direction and (ii) redirect the laser beam to the second reflector 644 along a second direction, which coincides with the second actuator-aperture axis 671. The second reflector 644 is disposed on the coupling frame 617C to (i) receive from the first reflector 642 the laser beam 615 along the second actuator-aperture axis 671, and (ii) redirect the laser beam to the lens 620 along a third direction, which coincides with the first actuator-aperture axis 611.

The lens 620 is configured to (i) receive from the second reflector 644 the incident laser beam 615 along the first actuator-aperture axis 611 through the first actuator aperture 634, and (ii) focus the transmitted laser beam 625 to a target surface 695. The target surface 695 (i) is spaced apart from the lens 620 by a working distance W along the first actuator-aperture axis 611, here along the z-axis, and (ii) extends transversely to the first actuator-aperture axis, here parallel to the (x,y)-plane, within a field of view defined by the scanning aperture 616. The first voice-coil actuator 630 includes two or more springs 632 arranged to compress and extend orthogonal to the first actuator-aperture axis 611, here along the y-axis. As such, when the first voice-coil actuator 630 has been activated, the springs 632 are configured to linearly move the lens 620 transversely to the first actuator-aperture axis 611. At a time “t”, the lens 620 has been linearly moved along a linear path perpendicular to the first actuator-aperture axis 611, such that an instance of its optical axis 621(t) has shifted by a corresponding lens displacement δy(t)≠0 relative to the first actuator-aperture axis. As described above in connection with FIGS. 2B-2C, 3A-3B, 4A-4B and 5A-5B, the finite lens displacement δy(t) causes that a corresponding instance of the transmitted laser beam 625(t) be redirected by the lens 620, through refraction, relative to the first actuator-aperture axis 611 to a point of the target surface 695 separated along the y-axis from an axial focal point 697(t) by a corresponding target displacement ΔY(t).

Note, however, that in FIG. 6A, which shows the instance of the scan head 610 at time t₁, the optical axis 621 of the lens 620 is displaced by a lens displacement δy(t₁) relative to the instant first actuator-aperture axis 611(t₁), and the first actuator-aperture axis is spaced apart from the transverse datum 619 by y_{C}(t₁)=Y₀. Under these conditions, the transmitted beam 625(t₁) impinges on the target surface 695 at a point that (i) is separated by the instant axial focal point 697(t₁) by a target displacement ΔY(t₁), but (ii) misses a predetermined point 699 by a distance δY_{C}. FIG. 6B shows that, at t₂, for a lens displacement of the optical axis 621 of the lens 620 relative to the instant first actuator-aperture axis 611(t₂) equal to the one at t₁, δy(t₂)=δy(t₁), the second voice-coil actuator 670 has been activated using a scanning-range extension procedure to move the first voice-coil actuator 630, and thus the first actuator-aperture axis and the lens, by an additional displacement δY_{C}. This shifts the first actuator-aperture axis 611 by δY_{C}. As such, at t₂ when δy(t₂)=δy(t₁), the transmitted beam 625(t₂) impinges on the target surface 695 at the predetermined point 699 separated along the y-axis from the δY_{C}-shifted axial focal point 697(t₂) by a target displacement ΔY(t₂)=ΔY(t₁).

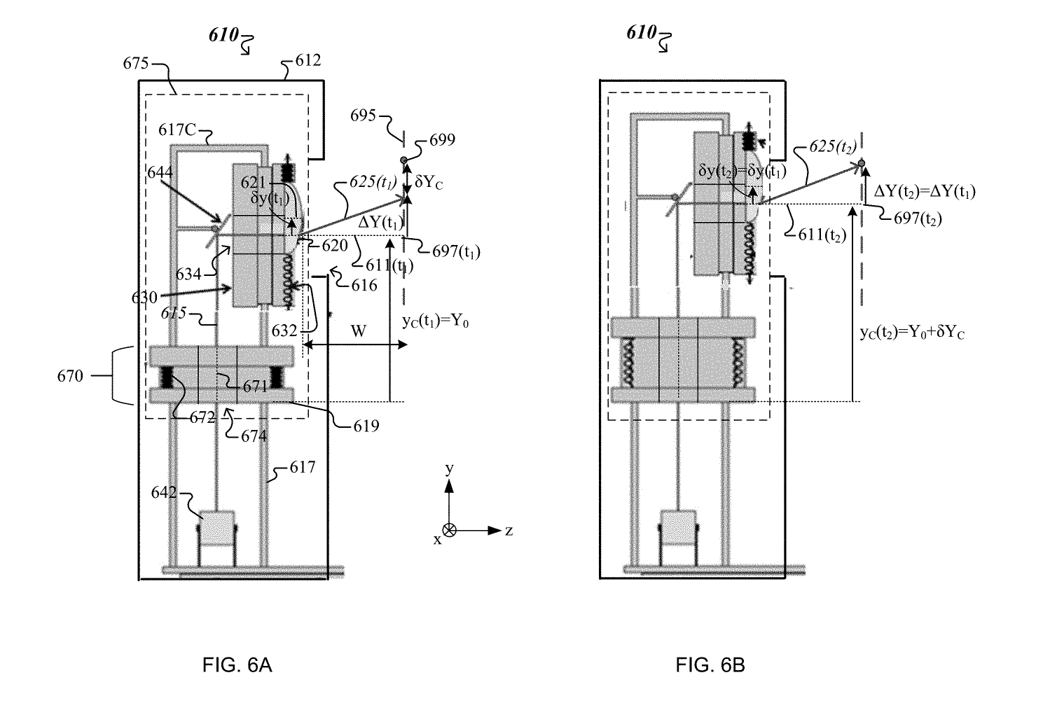

A scanning-range extension similar to the one described above can be implemented for a scan head that also has an additional voice-coil actuator used for autofocus, such as the scan head 410. Likewise, a scanning-range extension similar to the one described above can be implemented for the scan head 310. FIGS. 7A-7B are cross-section views, e.g., parallel to the (y,z)-plane, of instances of a scan head 710 that uses a fiber optic cable 750 to deliver a laser beam 715 to a lens 720 actuated by a combination of voice-coil actuators 730, 770 for extending a range over which the laser beam 725 transmitted through the lens is being scanned. The scan head 710 has a housing 712. In addition to the lens 720, the scan head 710 includes a first voice-coil actuator 730 and a second voice-coil actuator 770. The scan head 710 further includes an input optical port 714, e.g., implemented as the input port 314 described above in connection with FIGS. 3A-3B. The lens 720, the first voice-coil actuator 730, the second voice-coil actuator 770, and the input optical port 714 are encompassed by the housing 712.

The first voice-coil actuator 730 has a first actuator aperture 734, which has a first actuator-aperture axis 711, here along the z-axis. The lens 720 is coupled to the first voice-coil actuator 730 to cover the first actuator aperture 734. The first voice-coil actuator 730 is configured, e.g., like any one of the voice-coil actuators 130, 230, 330, 430, 530 or 630, to move the lens 720 transversely relative to the first actuator-aperture axis 711, here along the y-axis. The first voice-coil actuator 730 is coupled to the second voice-coil actuator 770 through a coupling frame 717C. A chassis 717 of the scan head 710 supports the second voice-coil actuator 770 at a fixed location of the housing 712. The coupling frame 717C is configured to orient the first voice-coil actuator 730 and the second voice-coil actuator 770 relative to each other such that, when activated, the second voice-coil actuator 770 moves the first voice-coil actuator, and thus the first actuator-aperture axis 711, along a direction of the lens 720's motion caused by the first voice-coil actuator, here along the y-axis. The second voice-coil actuator 770 includes two or more springs 772 arranged to compress and extend along the y-axis. As such, when the second voice-coil actuator 770 has been activated, the springs 772 are configured to cause the second voice-coil actuator 770 to displace the first voice-coil actuator 730, and thus the first actuator-aperture axis 711 and the lens 720, by an additional displacement δY_{C}≠0 relative to a transverse datum 719 (here a particular surface of the chassis 717). For instance, when the second voice-coil actuator 770 is not activated, e.g., when δY_{C}=0, the first actuator-aperture axis 711 is spaced apart from the transverse datum 719 by a predetermined transverse distance Y₀. The first voice-coil actuator 730 and the second voice-coil actuator 770 combined in this manner are said to form a voice-coil actuator assembly 775.

The housing 712 has a scanning aperture 716, which is an opening in the housing. The chassis 717 supports the voice-coil actuator assembly 775 adjacent to the scanning aperture 716. In this manner, the lens 720 coupled to the first voice-coil actuator 730 of the assembly (i) is oriented with its optical axis 721 along the z-axis, and (ii) is facing outside the housing 712 through the scanning aperture 716. The coupling frame 717C supports the input optical port 714 adjacent to a side of the lens 720 opposing the lens side facing the scanning aperture 716. The housing 712 can have a source opening (not shown in FIGS. 7A-7B) like the source opening 318 described above in connection with FIGS. 3A-3B. The fiber optic cable 750 is connected at its input end to a laser source, crosses inside the housing 712 (e.g., through the source opening), and is connected at its output end to the input optic port 714 adjacent to the lens 720. In this manner, the fiber optic cable 750 provides at its output end, during operation of the scan head 710, laser light from the laser source in the form of a laser beam 715 directed to the lens 720 along the first actuator-aperture axis 711.

The lens 720 is configured to (i) receive directly from the input optical port 714 the incident laser beam 715 along the first actuator-aperture axis 711 through the first actuator aperture 734, and (ii) focus the transmitted laser beam 725 to a target surface 795. The target surface 795 (i) is spaced apart from the lens 720 by a working distance W along the first actuator-aperture axis 711, here along the z-axis, and (ii) extends transversely to the first actuator-aperture axis, here parallel to the (x,y)-plane, within a field of view defined by the scanning aperture 716. The first voice-coil actuator 730 includes two or more springs 732 arranged to compress and extend orthogonal to the first actuator-aperture axis 711, here along the y-axis. As such, when the first voice-coil actuator 730 has been activated, the springs 732 are configured to linearly move the lens 720 transversely to the first actuator-aperture axis 711. At a time “t”, the lens 720 has been linearly moved along a linear path perpendicular to the first actuator-aperture axis 711, such that an instance of its optical axis 721(t) has shifted by a corresponding lens displacement δy(t)≠0 relative to the first actuator-aperture axis. As described above in connection with FIGS. 2B-2C, 3A-3B, 4A-4B, 5A-5B and 6A-6B, the finite lens displacement δy(t) causes that a corresponding instance of the transmitted laser beam 725(t) be redirected by the lens 720, through refraction, relative to the first actuator-aperture axis 711 to a point of the target surface 795 separated along the y-axis from an axial focal point 797(t) by a corresponding target displacement ΔY(t).

Note, however, that in FIG. 7A, which shows the instance of the scan head 710 at time t₁, the optical axis 721 of the lens 720 is displaced by a lens displacement δy(t₁) relative to the instant first actuator-aperture axis 711(t₁), and the first actuator-aperture axis is spaced apart from the transverse datum 619 by y_{C}(t₁)=Y₀. Under these conditions, the transmitted beam 725(t₁) impinges on the target surface 795 at a point that (i) is separated by the instant axial focal point 797(t₁) by a target displacement ΔY(t₁), but (ii) misses a predetermined point 799 by a distance δY_{C}. FIG. 7B shows that, at t₂, for a lens displacement of the optical axis 721 of the lens 720 relative to the instant first actuator-aperture axis 711(t₂) equal to the one at t₁, δy(t₂)=δy(t₁), the second voice-coil actuator 770 has been activated using a scanning-range extension procedure to move the first voice-coil actuator 730, and thus the first actuator-aperture axis and the lens, by an additional displacement δY_{C}. This shifts the first actuator-aperture axis 711 by δY_{C}. As such, at t₂ when δy(t₂)=δy(t₁), the transmitted beam 725(t₂) impinges on the target surface 795 at the predetermined point 799 separated along the y-axis from the δY_{C}-shifted axial focal point 697(t₂) by a target displacement ΔY(t₂)=ΔY(t₁).

A scanning-range extension similar to the one described above can be implemented for a scan head that also has an additional voice-coil actuator used for autofocus, such as the scan head 510. Referring now to FIGS. 6A-6B and 7A-7B, the second voice-coil actuator 670, 770 of the scan head 610, 710 can shift the first actuator-aperture axis 611, 711 along the y-axis over a maximum y-displacement δY_{CMAX}. In some implementations of the second voice-coil actuator 670, 770, the maximum y-displacement can be between 100-200 mm.

In some cases, to print/burn a pattern having a particular transverse size on a target surface 295, 395, e.g., disposed parallel to the (x,y)-plane, the target surface will not be translated relative to the scan head 210, 310 along the transverse direction 291, 391, e.g., along the x axis, while the scan head scans the transmitted laser beam 225, 335 along a scanning direction, e.g., along the y-axis, normal to the transverse direction. Instead, the target surface 295, 395 will be kept at rest relative to the scan head 210, 310. For such cases, the scan head 210, 310 can be modified to shift the actuator-aperture axis 211, 311 parallel to the transverse direction, here along the x-axis, over a distance δX_{C} that exceeds the particular transverse size of the particular pattern. The modification of the scan head 210, 410, 610 is described first, followed by the modification of the scan head 310, 510, 710.

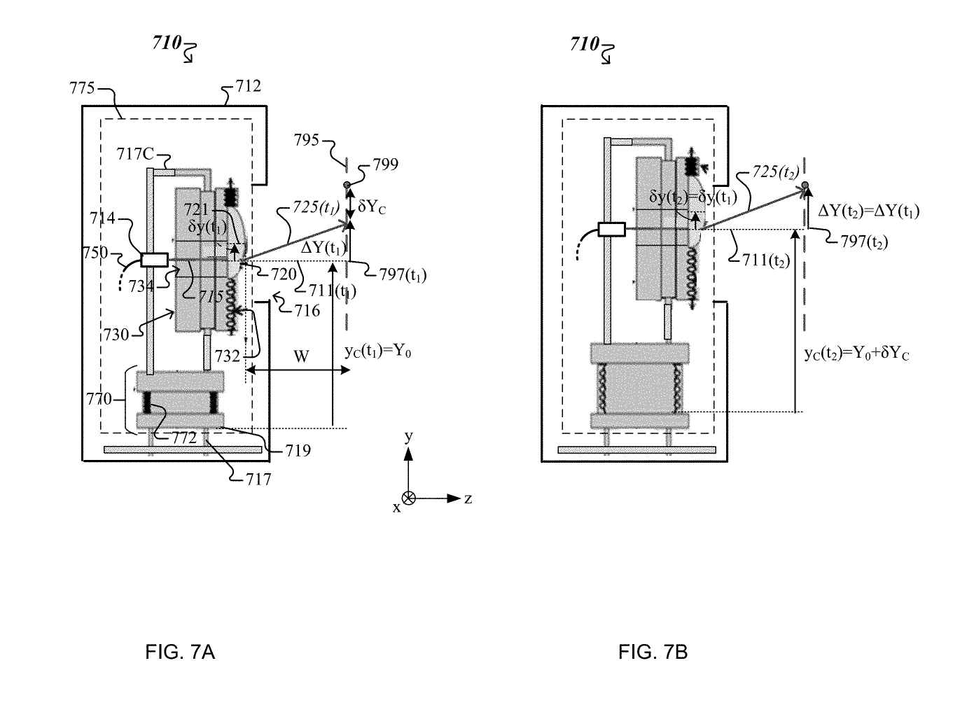

FIG. 8 is a cross-section view, e.g., parallel to the (x,y)-plane, of a laser marking system 800 which includes a scan head 810 that uses discrete beam-steering optics 842, 844 to deliver a laser beam 815 to a lens 820 actuated by a combination of a voice-coil actuator 830 and a translation stage 880 for scanning the laser beam transmitted through the lens along transverse directions orthogonal to each other. The scan head 810 has a housing 812. In addition to the beam steering optics 842, 844 and the lens 820, the scan head 810 includes a voice-coil actuator 830 and a translation stage 880. The lens 820, the voice-coil actuator 830, the translation stage 880, and the beam steering optics 842, 844 are encompassed by the housing 812.

The voice-coil actuator 830 has an actuator aperture 834, which has an actuator-aperture axis 811, here along the z-axis (into the page). The lens 820 is coupled to the voice-coil actuator 830 to cover the actuator aperture 834. The voice-coil actuator 830 is configured, e.g., like any one of the voice-coil actuators 130, 230, 330, 430, 530, 630 or 730, to move the lens 820 transversely relative to the actuator-aperture axis 811, here along the y-axis. Here, the translation stage 880 includes a rail 882 and a shuttle 884, also referred to as slide table. The rail 882 is supported, at a fixed location of the housing 812, directly on, or itself is a portion of, a chassis of the housing. For example, the rail 882 can be implemented as a thread shaft and stepper motor. As another example, the rail 882 can be a groove of the chassis. In either case, actuators used to move the shuttle 884 can be a solenoid or a DC Servo. The voice-coil actuator 830 is coupled to the shuttle 884 through a coupling frame 817C. The coupling frame 817C is configured to orient the voice-coil actuator 830 and the translation stage 880 relative to each other such that, when activated, the shuttle 884 moves the voice-coil actuator, and thus the actuator-aperture axis 811, orthogonal to a direction of the lens 820's motion caused by the voice-coil actuator, here along the y-axis. As such, when activated, the shuttle 884 is configured to displace the voice-coil actuator 830, and thus the actuator-aperture axis 811 and the lens 820, by a transverse displacement δX_{C}≠0 relative to a transverse datum 889 (here a particular surface of the rail 882).

The housing 812 has an input optical port 814 implemented like the input optical port 214 described above in connection with FIG. 2A. A laser source 802 provides, during operation of the laser marking system 800, through the input optical port 814 of the scan head 810 a laser beam 815 along a first direction, e.g., parallel to the x-axis. The housing 812 also has a scanning aperture 816, which is another opening in the housing. The translation stage 880 supports the voice-coil actuator 830 adjacent to the scanning aperture 816. In this manner, the lens 820 coupled to the voice-coil actuator 830 (i) is oriented with its optical axis along the z-axis (here into the page), and (ii) is facing outside the housing 812 through the scanning aperture 816.

In the example illustrated in FIG. 8, the beam steering optics 842, 844 are (i) supported by the shuttle 884 and the coupling frame 817C, respectively, and (ii) implemented like the first and second reflectors 242, 244 described above in connection with FIGS. 2A-2C. In this manner, the first reflector 842 is disposed on the shuttle 884 to (i) receive from the input port the laser beam 815 along the first direction and (ii) redirect the laser beam to the second reflector 844 along a second direction, here along the y-axis. The second reflector 844 is disposed on the coupling frame 817C to (i) receive from the first reflector 842 the laser beam 815 along the y-axis, and (ii) redirect the laser beam to the lens 820 along a third direction (into the page), which coincides with the actuator-aperture axis 811. The lens 820 is configured to (i) receive from the second reflector 844 the incident laser beam 815 along the actuator-aperture axis 811 through the actuator aperture 834, and (ii) focus the transmitted laser beam (not visible in FIG. 8) to a target surface 895.

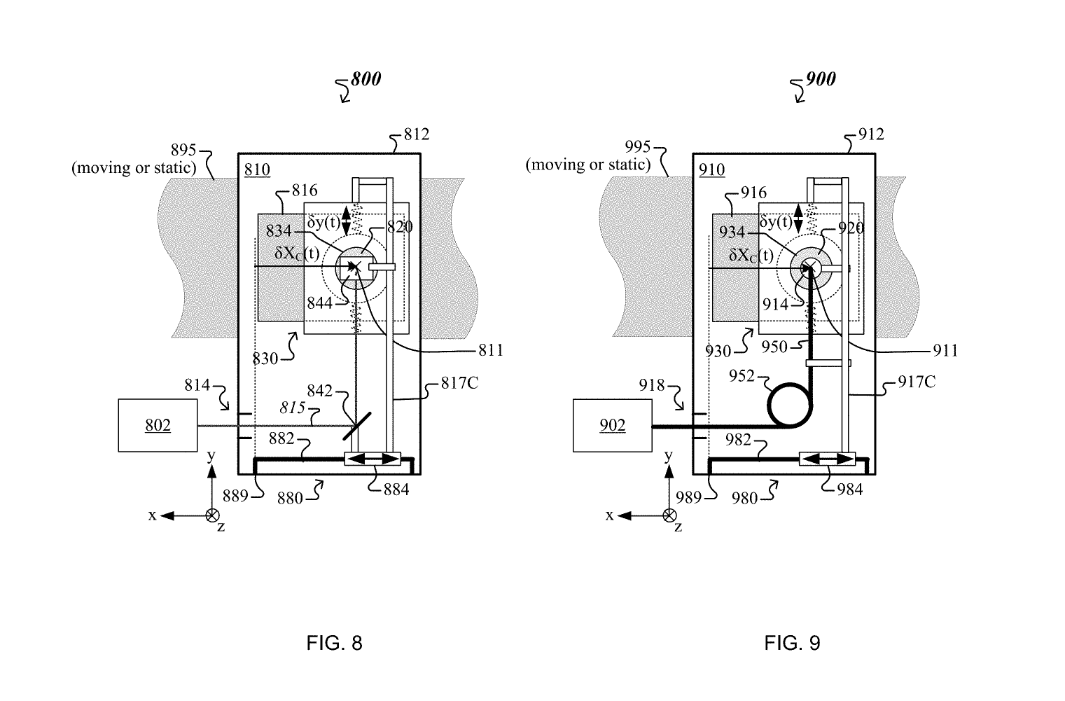

FIG. 9 is a cross-section view, e.g., parallel to the (x,y)-plane, of a laser marking system 900 which includes a scan head 910 that uses a fiber optic cable 950 to deliver a laser beam to a lens 920 actuated by a combination a voice-coil actuator 930 and a translation stage 980 for scanning the laser beam transmitted through the lens along transverse directions orthogonal to each other. The scan head 910 has a housing 912. In addition to the lens 920, the scan head 910 includes the voice-coil actuator 930 and the translation stage 980. The scan head 910 further includes an input optical port 914, e.g., implemented as the input port 314 described above in connection with FIGS. 3A-3B. The lens 920, the voice-coil actuator 930, the translation stage 980, and the input optical port 914 are encompassed by the housing 912.

The voice-coil actuator 930 has an actuator aperture 934, which has an actuator-aperture axis 911, here along the z-axis (into the page). The lens 920 is coupled to the voice-coil actuator 930 to cover the actuator aperture 934. The voice-coil actuator 930 is configured, e.g., like any one of the voice-coil actuators 130, 230, 330, 430, 530, 630 or 730, to move the lens 920 transversely relative to the actuator-aperture axis 911, here along the y-axis. Here, the translation stage 980 includes a rail 982 and a shuttle 984. The rail 982 is supported, at a fixed location of the housing 912, directly on, or itself is a portion of, a chassis of the housing. The translation stage 980 can be implemented similarly to the translation stage 880 described above in connection with FIG. 8.

The voice-coil actuator 930 is coupled to the shuttle 984 through a coupling frame 917C. The coupling frame 917C is configured to orient the voice-coil actuator 930 and the translation stage 980 relative to each other such that, when activated, the shuttle 984 moves the voice-coil actuator, and thus the actuator-aperture axis 911, orthogonal to a direction of the lens 920's motion caused by the voice-coil actuator, here along the y-axis. As such, when activated, the shuttle 984 is configured to displace the voice-coil actuator 930, and thus the actuator-aperture axis 911 and the lens 920, by a transverse displacement δX_{C}≠0 relative to a transverse datum 989 (here a particular surface of the rail 982).

The housing 912 has a scanning aperture 916, which is an opening in the housing. The translation stage 980 supports the voice-coil actuator 930 adjacent to the scanning aperture 916. In this manner, the lens 920 coupled to the voice-coil actuator 930 (i) is oriented with its optical axis along the z-axis (here into the page), and (ii) is facing outside the housing 912 through the scanning aperture 916. The coupling frame 917C supports the input optical port 914 adjacent to a side of the lens 920 opposing the lens side facing the scanning aperture 916. The housing 912 can have a source opening 918 configured like the source opening 318 described above in connection with FIGS. 3A-3B. The fiber optic cable 950 is connected at its input end to a laser source 902, crosses inside the housing 912 (e.g., through the source opening 918), and is connected at its output end to the input optic port 914 adjacent to the lens 920. In this manner, the fiber optic cable 950 provides at its output end, during operation of the scan head 910, laser light from the laser source 902 in the form of a laser beam (not visible in FIG. 9) directed to the lens 920 along the actuator-aperture axis 911. The lens 920 is configured to (i) receive directly from the input optical port 914 the incident laser beam along the actuator-aperture axis 911 through the actuator aperture 934, and (ii) focus the transmitted laser beam (not visible in FIG. 9) to a target surface 995.

Note that the fiber optic cable 950 has been provided with a loop 952 of extra length to avoid stressing the fiber optic cable adjacent to the source opening 918, and adjacent to the input optic port 914 (which can be implemented as a fiber optic cable connector). The loop 952 can be inside the housing 912 or outside the housing 912 (e.g. the laser can cross inside the housing 912 through the optic port 914 being located in the housing 912). Additionally, the loop 952 prevents stressing the fiber optic cable 950 during operation of the translation stage 980, when the shuttle 984 moves, along the x-axis, the input optic port 914, and thus the output end of the fiber optic cable.

Referring now to both FIGS. 8 and 9, the target surface 895, 995 (i) is spaced apart from the lens 820, 920 by a working distance along the actuator-aperture axis 811, 911, here into the page, and (ii) extends transversely to the actuator-aperture axis, here parallel to the (x,y)-plane, within a field of view defined by the scanning aperture 816, 916. While printing on the target surface 895, 995, the target surface 895, 995 can be moved along the x-axis (e.g., by a conveyor) to a specific x-coordinate, before bringing the target surface 895, 995 to a stop. The target surface 895, 995 will be stationary for a time interval, so motion of the actuator-aperture axis 811, 911 along the x-axis during this time interval will be caused by activating the shuttle 884, 984 to shift the actuator-aperture axis 811, 911 by a desired transverse displacement along the x-axis, as described below.

The voice-coil actuator 830, 930 includes two or more springs arranged to compress and extend orthogonally to the actuator-aperture axis 811, 911 here along the y-axis. As such, when the voice-coil actuator 830, 930 has been activated, the springs are configured to linearly move the lens 820, 920 transversely to the actuator-aperture axis 811, 911. At a time “t”, the lens 820, 920 has been linearly moved along a linear path perpendicular to the first actuator-aperture axis 811, 911, such that an instance of its optical axis has shifted by a corresponding lens displacement δy(t)≠0 relative to the actuator-aperture axis. As described above in connection with FIGS. 2B-2C, 3A-3B, 4A-4B and 5A-5B, the finite lens displacement δy(t) causes that a corresponding instance of the transmitted laser beam be redirected by the lens 820, 920 through refraction, relative to the actuator-aperture axis 811, 911 to a desired level of the target surface 895, 995 separated along the y-axis from the actuator-aperture axis by a corresponding target displacement ΔY(t) (not visible in FIGS. 8 and 9). Additionally, each of FIGS. 8 and 9 shows that, at the same time, the translation stage 880, 980 has been activated using a transverse-range extension procedure to move the voice-coil actuator 830, 930 and thus the actuator-aperture axis 811, 911 and the lens, by a transverse displacement δX_{C}(t) corresponding to a desired lateral distance from the transverse datum 889, 989. This has shifted the actuator-aperture axis 811, 911 by δX_{C}(t). As a result, the transmitted beam impinges on the target surface 895, 995 at a point separated (i) along the y-axis by a desired target displacement ΔY(t) from the actuator-aperture axis 811, 911, and (ii) along the x-axis by a desired transverse displacement δX_{C}(t) from the transverse datum 889, 989.

The translation stage 880, 980 of the scan head 810, 810 can shift the actuator-aperture axis 811, 911 along the x-axis over a maximum x-displacement δX_{CMAX}. In some Implementations of the translation stage 880, 980, the maximum x-displacement can be between 50-200 mm.

In some implementations, the translation stage 880, 980 can be disposed externally to the housing 812, 912 of the scan head 810, 910. This corresponds to mounting the entire scan head 210, 310 on the shuttle 884, 984 of the translation stage 880, 980. In the case of the scan head 310 mounted on the shuttle 984 of the translation stage 980, the loop 352 of the fiber optic cable 350 can wind and unwind to accommodate for the input end of the fiber optic cable 650 coupled to the laser source 302 “moving” near or away from the source opening 318. In the case of the scan head 210 mounted on the shuttle 884 of the translation stage 880, a telescopic hollow tube with a constant inner diameter can be disposed along the x-axis connected at an input end to the laser source 202 and at an opposing output end the input optical port 214. In this manner, the telescopic hollow tube can extend and collapse to shield the laser beam 215 from the environment as the shuttle 984 moves the scan head 210 between its nearest, to its farther, distance along the x-axis between the laser source 202 and the input optical port 214.

The scan heads 410, 510, 610, 710, 810 and 910 represent modifications of the scan heads 210, 310 in which the voice-coil actuator 230, 330—to which the lens 220, 320 has been coupled—was combined with one other voice-coil actuator or translation stage. Other scan head embodiments that include combinations of the voice-coil actuator 230, 330—to which the lens 220, 320 has been coupled—with two or more from among the disclosed voice-coil actuators and translation stages will be described below in connection with FIG. 10.

FIG. 10 is a diagram of a laser marking system 1000 which includes a laser scanning device 1010, a laser source 1002, and a controller 1090. In this example, the laser marking system 1000 is used to produce a pattern 1099 on a target surface 1095, the latter spaced apart by a working distance W from the laser scanning device 1010 along the z-axis, and arranged parallel to the (x,y)-plane.

The laser source 1002 is configured and arranged to provide a laser beam 1015. The laser scanning device 1010 includes an optical port 1014 configured and arranged to receive the laser beam 1015 from the laser source 1002. The laser scanning device 1010 also includes a lens 1020 configured and arranged to focus the laser beam 1025 to modify the target surface 1095 of a material to be marked. Additionally, the laser scanning device 1010 includes an electrically controlled linear actuator 1030 with an actuator aperture, which has an actuator-aperture axis 1011 oriented along the z-axis. The lens 1020 is coupled to the electrically controlled linear actuator 1030 to cover the actuator aperture. The electrically controlled linear actuator 1030 is configured to move the lens 1020 linearly. In this manner, the electrically controlled linear actuator 1030 causes the laser beam 1025 to scan across the target surface 1095 as a result of changes in a refraction angle, of the laser beam passing through the lens 1020, caused by the linear movement. In the example illustrated in FIG. 10, the electrically controlled linear actuator 1030 scans the laser beam 1025 transmitted through the lens 1020 parallel to the (y,z)-plane.

In some implementations, the electrically controlled linear actuator 1030 coupled with the lens 1020 can be configured similar to the voice-coil actuator 130. In some implementations, the electrically controlled linear actuator 1030 coupled with the lens 1020 can be configured similar to the voice-coil actuator 130R. Optionally, the electrically controlled linear actuator 1030 can be rotated about the actuator-aperture axis 1011, such that it scans the laser beam 1025 transmitted through the lens 1020 parallel to the (x,z)-plane.

In some embodiments described in detail below, the laser scanning device 1010 can include one, two or all of an electrically controlled autofocus actuator 1060, an electrically controlled scanning-range extender actuator 1070 or an electrically controlled sideways-mover actuator 1080, two or more of which can be coupled together by a chassis 1017 of the scanning device 1010.

The controller 1090 is coupled through a communication interface 1094 with, and is configured to control, the laser scanning device 1010. In some implementations, the controller 1090 is coupled through the communication interface 1094 with both the laser source 1002 and the laser scanning device 1010, and is configured to control both of them. The controller 1090 includes a hardware processor 1092 and memory 1096 coupled with the hardware processor. In some implementations, at least some of the components of the controller are internal to the laser scanning device 1010. The memory is configured to store scanning instructions 1098 that, when performed by the hardware processor 1092, cause the controller 1090 to send electrical signals to the electrically controlled linear actuator 1030 to move the lens 1020 to effect dot matrix or vector type laser marking on products, e.g., like the target surface 1095. Here, the target surface 1095 suitably moves, e.g., along the x-axis, in front of the laser scan head 1010 on a conveyor 1091 in a product manufacturing or packaging facility, for instance. The laser beam 1025 transmitted through the lens 1020 is used to print, mark and/or burn a pattern 1099 on the surface 1095 of the material to be marked (e.g., by ablation or using phase changing inks). The instructions 1098 can further cause the controller 1090 to send electrical signals to (i) the electrically controlled autofocus actuator 1060 to move the lens 1020 axially to effect focusing of the lens onto the target surface 1095, and (ii) the electrically controlled scanning-range extender actuator 1070 and/or the electrically controlled sideways-mover actuator 1080 to shift the actuator-aperture axis 1011 to increase the printing range over the target surface 1095.

In some implementations, the laser scanning device 1010 can be implemented as the scan head 210. Here, the laser scanning device 1010 includes discrete relay optics, e.g., 242, 244 (not shown in FIG. 10), arranged and configured to redirect the laser beam 1015 received through the optical port 1014, and provide the redirected laser beam to the lens 1020 along the actuator-aperture axis 1011. In other implementations, the laser scanning device 1010 can be implemented as the scan head 310. Here, the laser marking system 1000 includes a fiber optics cable, e.g., 350 (not shown in FIG. 10), and the optical port 1014 is configured as a fiber optic cable connector disposed adjacent to the lens 1020. The fiber optics cable is coupled at its input end to the laser source 1002 and at its output end to the fiber optic cable connector of the laser scanning device 1010 to guide laser light from the laser source to the laser scanning device. In this manner, the laser light output through the fiber optic cable connector is provided as the laser beam 1015 along the actuator-aperture axis 1011 directly to the lens 1020.

In a first embodiment, the laser scanning device 1010 suitably includes, in addition to the lens 1020 and the electrically controlled linear actuator 1030 coupled with the lens to scan the transmitted laser beam 1025 in a scanning plane, here parallel to the (y,z)-plane, the electrically controlled autofocus actuator 1060 coupled with the electrically controlled linear actuator 1030. The electrically controlled autofocus actuator 1060 (e.g., implemented as the voice-coil actuator 460, 560) will controllably move the electrically controlled linear actuator 1030, and thus the lens 1020, along the actuator-aperture axis 1011 to ensure that the laser beam 1025 that impinges on the target surface 1095 is in focus. For example, the first embodiment of the laser scanning device 1010 can be implemented as the scan head 410 described in detail in connection with FIGS. 4A-4B. As another example, the first embodiment of the laser scanning device 1010 can be implemented as the scan head 510 described in detail in connection with FIGS. 5A-5B.

In a second embodiment, the laser scanning device 1010 suitably includes, in addition to the lens 1020 and the electrically controlled linear actuator 1030 coupled with the lens to scan the transmitted laser beam 1025 in the scanning plane, the electrically controlled scanning-range extender actuator 1070 coupled with the electrically controlled linear actuator 1030. The electrically controlled scanning-range extender actuator 1070 (e.g., implemented as the voice-coil actuator 670, 770) will shift the electrically controlled linear actuator 1030 and its actuator-aperture axis 1011 transversely within the scanning plane to ensure that the actuator-aperture axis 1011 intersects the target surface 1095 at a desired elevation coordinate, along the y-axis relative to a datum 1019 (e.g., a point of a chassis of the laser scanning device 1010). For example, the second embodiment of the laser scanning device 1010 can be implemented as the scan head 610 described in detail in connection with FIGS. 6A-6B. As another example, the second embodiment of the laser scanning device 1010 can be implemented as the scan head 710 described in detail in connection with FIGS. 7A-7B.

In a third embodiment, the laser scanning device 1010 suitably includes, in addition to the lens 1020 and the electrically controlled linear actuator 1030 coupled with the lens to scan the transmitted laser beam 1025 in the scanning plane, the electrically controlled sideways-mover actuator 1080 coupled with the electrically controlled linear actuator 1030. The third embodiment of the laser scanning device 1010 can be used when the conveyor 1091 is at rest or moving relating to the laser scanning device. The electrically controlled sideways-mover actuator 1080 (e.g., implemented as the translation stage 880, 980) will shift the electrically controlled linear actuator 1030 and its actuator-aperture axis 1011 transversely within the (x,z)-plane, normal to the scanning plane, to ensure that the actuator-aperture axis 1011 intersects the target surface 1095 at a desired lateral coordinate, along the x-axis relative to a datum 1019. For example, the third embodiment of the laser scanning device 1010 can be implemented as the scan head 810 described in detail in connection with FIG. 8. As another example, the third embodiment of the laser scanning device 1010 can be implemented as the scan head 910 described in detail in connection with FIG. 9.

In a fourth embodiment, the laser scanning device 1010 suitably includes, in addition to the lens 1020 and the electrically controlled linear actuator 1030 coupled with the lens to scan the transmitted laser beam 1025 in the scanning plane, the electrically controlled autofocus actuator 1060 coupled with the electrically controlled linear actuator 1030, and the electrically controlled scanning-range extender actuator 1070 coupled with the electrically controlled autofocus actuator 1060. Here, the electrically controlled scanning-range extender actuator 1070 (e.g., implemented as the voice-coil actuator 670, 770) will shift the electrically controlled autofocus actuator 1060, and thus the electrically controlled linear actuator 1030 and its actuator-aperture axis 1011, transversely within the scanning plane to ensure that the actuator-aperture axis 1011 intersects the target surface 1095 at a desired elevation coordinate, along the y-axis relative to a datum 1019. Additionally, the electrically controlled autofocus actuator 1060 (e.g., implemented as the voice-coil actuator 460, 560) will controllably move the electrically controlled linear actuator 1030, and thus the lens 1020, along the y-shifted actuator-aperture axis 1011 to ensure that the laser beam 1025 that impinges on the target surface 1095 at the desired elevation coordinate is in focus.

In a fifth embodiment, the laser scanning device 1010 suitably includes, in addition to the lens 1020 and the electrically controlled linear actuator 1030 coupled with the lens to scan the transmitted laser beam 1025 in the scanning plane, the electrically controlled autofocus actuator 1060 coupled with the electrically controlled linear actuator 1030, and the electrically controlled sideways-mover actuator 1080 coupled with the electrically controlled autofocus actuator 1060. The fifth embodiment of the laser scanning device 1010 can be used when the conveyor 1091 is at rest or moving relating to the laser scanning device. Here, the electrically controlled sideways-mover actuator 1080 (e.g., implemented as the translation stage 880, 980) will shift the electrically controlled autofocus actuator 1060, and thus the electrically controlled linear actuator 1030 and its actuator-aperture axis 1011, transversely within the (x,z)-plane, normal to the scanning plane, to ensure that the actuator-aperture axis 1011 intersects the target surface 1095 at a desired lateral coordinate, along the x-axis relative to a datum 1019. Additionally, the electrically controlled autofocus actuator 1060 (e.g., implemented as the voice-coil actuator 460, 560) will controllably move the electrically controlled linear actuator 1030, and thus the lens 1020, along the x-shifted actuator-aperture axis 1011 to ensure that the laser beam 1025 that impinges on the target surface 1095 at the desired lateral coordinate is in focus.

In a sixth embodiment, the laser scanning device 1010 suitably includes, in addition to the lens 1020 and the electrically controlled linear actuator 1030 coupled with the lens to scan the transmitted laser beam 1025 in the scanning plane, the electrically controlled scanning-range extender actuator 1070 coupled with the electrically controlled linear actuator 1030, and the electrically controlled sideways-mover actuator 1080 coupled with the electrically controlled scanning-range extender actuator 1070. The sixth embodiment of the laser scanning device 1010 can be used when the conveyor 1091 is at rest or moving relating to the laser scanning device. Here, the electrically controlled sideways-mover actuator 1080 (e.g., implemented as the translation stage 880, 980) will shift the electrically controlled scanning-range extender actuator 1070, and thus the electrically controlled linear actuator 1030 and its actuator-aperture axis 1011, transversely within the (x,z)-plane, normal to the scanning plane, to ensure that the actuator-aperture axis 1011 intersects the target surface 1095 at a desired lateral coordinate, along the x-axis relative to a datum 1019. Additionally, the electrically controlled scanning-range extender actuator 1070 (e.g., implemented as the voice-coil actuator 670, 770) will shift the electrically controlled linear actuator 1030 and its x-shifted actuator-aperture axis 1011 transversely within the x-shifted scanning plane to ensure that the x- and y-shifted actuator-aperture axis 1011 intersects the target surface 1095 at a desired elevation coordinate, along the y-axis relative to the datum 1019, at the desired lateral coordinate.

In a seventh embodiment, the laser scanning device 1010 suitably includes, in addition to the lens 1020 and the electrically controlled linear actuator 1030 coupled with the lens to scan the transmitted laser beam 1025 in the scanning plane, the electrically controlled autofocus actuator 1060 coupled with the electrically controlled linear actuator 1030, the electrically controlled scanning-range extender actuator 1070 coupled with the electrically controlled autofocus actuator 1060, and the electrically controlled sideways-mover actuator 1080 coupled with the electrically controlled scanning-range extender actuator 1070. The seventh embodiment of the laser scanning device 1010 can be used when the conveyor 1091 is at rest or moving relating to the laser scanning device. Here, the electrically controlled sideways-mover actuator 1080 (e.g., implemented as the translation stage 880, 980) will shift the electrically controlled scanning-range extender actuator 1070, and thus the electrically controlled autofocus actuator 1060 and the electrically controlled linear actuator 1030 and its actuator-aperture axis 1011, transversely within the (x,z)-plane, normal to the scanning plane, to ensure that the actuator-aperture axis 1011 intersects the target surface 1095 at a desired lateral coordinate, along the x-axis relative to a datum 1019. Further, the electrically controlled scanning-range extender actuator 1070 (e.g., implemented as the voice-coil actuator 670, 770) will shift the electrically controlled autofocus actuator 1060 and thus the electrically controlled linear actuator 1030 and its x-shifted actuator-aperture axis 1011 transversely within the x-shifted scanning plane to ensure that the x- and y-shifted actuator-aperture axis 1011 intersects the target surface 1095 at a desired elevation coordinate, along the y-axis relative to the datum 1019, at the desired lateral coordinate. Furthermore, the electrically controlled autofocus actuator 1060 (e.g., implemented as the voice-coil actuator 460, 560) will controllably move the electrically controlled linear actuator 1030, and thus the lens 1020, along the x- and y-shifted actuator-aperture axis 1011 to ensure that the laser beam 1025 that impinges on the target surface 1095 at the desired lateral coordinate and elevation coordinate is in focus.

A few embodiments have been described in detail above, and various modifications are possible. While this specification contains many specifics, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

The controller 1090 can be one controller, as shown, or the controller 1090 can be more than one controller 1090. The controller(s) 1090 can be integrated with respective components of the system 1000, as appropriate. In various implementations, one or more controllers 1090 can be implemented using one or more programmable hardware processors executing one or more computer programs (e.g., operating system code embedded in firmware and/or application code stored in a non-transitory computer-readable medium), special purpose logic circuitry (e.g., using FPGA (field programmable gate array) or ASIC (application specific integrated circuit) circuitry), or a combination thereof.

Hardware processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, such as a mobile telephone, a personal digital assistant (PDA), a mobile audio or video player, a controller for a laser printer/marking device, to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Other embodiments fall within the scope of the following claims.

What is claimed is:

1. A laser scanning device for marking objects, the laser scanning device comprising:
an optical port configured and arranged to receive a laser beam;
a lens configured and arranged to focus the laser beam to modify a surface of a material to be marked; and
an electrically controlled linear actuator coupled with the lens, the electrically controlled linear actuator being configured to move the lens linearly, thereby causing the laser beam to scan across the surface of the material to be marked as a result of changes in a refraction angle, of the laser beam passing through the lens, caused by the linear movement.

2. The laser scanning device of claim 1, comprising:
a first reflector optically coupled with the optical port; and
a second reflector optically coupled with the first reflector and the lens,
wherein the first reflector is arranged to receive the laser beam from the optical port along a first direction, and configured to redirect the laser beam to the second reflector along a second direction, and
wherein the second reflector is arranged to receive the laser beam along the second direction, and redirect the laser beam to the lens along a third direction.

3. The laser scanning device of claim 2, wherein
the first reflector comprises a first mirror, and
the second reflector comprises a second mirror.

4. The laser scanning device of claim 2, comprising:
a translation stage that supports the first reflector and the second reflector, in addition to the electrically controlled linear actuator and thus the lens,
wherein the translation stage is configured to move, as a unit, each of the first mirror, the second mirror, the electrically controlled linear actuator, and the lens, along a line that is parallel to the first direction.

5. The laser scanning device of claim 4 or 10, wherein the translation stage comprises a table, a thread shaft, and a stepper motor.

6. The laser scanning device of claim 2, wherein the second direction is along an X dimension in a three dimensional space, the first reflector is arranged in a plane tilted at a fixed forty five degree angle relative to a (X,Z)-plane and normal to a (X,Y)-plane in the three dimensional space, the third direction is along a Y dimension in the three dimensional space, the second mirror is arranged in a plane tilted at a fixed forty five degree angle relative to the (X,Z)-plane and normal to a (Y,Z)-plane in the three dimensional space, and the first direction is along a Z dimension in the three dimensional space.

7. The laser scanning device of claim 2 or 4, wherein
the electrically controlled linear actuator is a first electrically controlled linear actuator configured to move the lens along the second direction, and
the laser scanning device further comprises a second electrically controlled linear actuator coupled with the first electrically controlled linear actuator, the second electrically controlled linear actuator being configured to move the first electrically controlled linear actuator, and thus the lens, along the third direction to adjust the focus of the laser beam on the surface of the material to be marked.

8. The laser scanning device of claim 2 or 4 or 7, further comprising a third electrically controlled linear actuator coupled with the first electrically controlled linear actuator, the third electrically controlled linear actuator being configured to move, as a unit, the second mirror and the first electrically controlled linear actuator, and thus the lens, along the second direction to adjust a centered position of the lens, thereby providing an increased marking area for the laser scanning device.

9. The laser scanning device of claim 1, wherein the optical port comprises a fiber optic cable connector configured to hold an output end of a fiber optic cable, the fiber optic cable connector disposed adjacent to the lens and arranged to direct to the lens along a third direction the laser beam guided through the fiber optic cable and output at its output end.

10. The laser scanning device of claim 9, comprising:
a translation stage that supports the fiber optic cable connector, and the electrically controlled linear actuator and thus the lens;
wherein the translation stage is configured to move, as a unit, each of the fiber optic cable connector, the electrically controlled linear actuator, and the lens, along a line that is parallel to a first direction orthogonal to the third direction.

11. The laser scanning device of claim 9 or 10, wherein the electrically controlled linear actuator is a first electrically controlled linear actuator configured to move the lens along a second dimension orthogonal to the first and third directions, and wherein the laser scanning device comprises a second electrically controlled linear actuator coupled with the first electrically controlled linear actuator, the second electrically controlled linear actuator being configured to move, as a unit, the fiber optic cable connector, the first electrically controlled linear actuator, and thus the lens, farther along the second dimension to adjust a centered position of the lens, thereby providing an increased marking area for the laser scanning device.

12. The laser scanning device of claim 9 or 10 or 11, further comprising a third electrically controlled linear actuator coupled between the first electrically controlled linear actuator and the second electrically controlled linear actuator, the third electrically controlled linear actuator being configured to move the first electrically controlled linear actuator, and thus the lens, along the third direction to adjust the focus of the laser beam on the surface of the material to be marked.

13. The laser scanning device of any of claims 1-12, wherein a ratio of a diameter of the lens divided by a diameter of the laser beam is between 1.1 and 5.1, between 1.1 and 4.1, between 1.1 and 3.1, or between 1.1 and 2.1.

14. The laser scanning device of claim 13, wherein the diameter of the laser beam is about 2.5 mm, the diameter of the lens is about 3.5 mm, and a scanning distance covered by the changes in the refraction angle between 15 mm and 57 mm.

15. The laser scanning device of any one of the preceding claims, wherein any of the electrically controlled linear actuators referenced therein comprises either a voice-coil actuator or a linear DC motor.

16. The laser scanning device of any one of the preceding claims, wherein the linear motion of the lens caused by the electrically controlled actuator coupled with the lens is along a linear path or an arcuate path.

17. A laser marking system comprising:
a laser scan head comprising the laser scanning device of any one of claims 1-8; and
a laser source configured and arranged to provide the laser beam to the optical port of the laser scan head along the first direction.

18. A laser marking system comprising:
a laser scan head comprising the laser scanning device of any one of claims 9-12;
a laser source configured and arranged to provide the laser beam; and
the fiber optic cable connected at its input end to the laser source and at its output end to the fiber optic cable connector of the laser scan head to guide the laser beam from the laser source to the laser scan head.

19. The laser making system of claim 17 or 18, comprising:
a controller coupled with the laser scan head and configured to send electrical signals to the electrically controlled linear actuator to move the lens to effect dot matrix or vector type laser marking on products, when the products move in front of the laser scan head on a conveyor in a product manufacturing or packaging facility.

20. A method of operating the laser system of claim 19, substantially as shown and described.
